(19) United States
(12) Patent Application Publication
(10) Pub. No.: US 2022/0215396 A1
(43) Pub. Date: Jul. 7, 2022

(54) UNATTENDED SHOP SYSTEM AND UNATTENDED SHOP MANAGEMENT METHOD

(71) Applicant: PANASONIC INTELLECTUAL PROPERTY MANAGEMENT CO., LTD., Osaka (JP)

(72) Inventors: Akihiro UEKI, Kanagawa (JP); Masaki SHIKANAI, Kanagawa (JP); Mamoru NOBUE, Tochigi (JP); Hidehiko NAWAI, Osaka (JP); Kouhei NISHINO, Tokyo (JP); Tomohiro MATSUDA, Kanagawa (JP)

(73) Assignee: PANASONIC INTELLECTUAL PROPERTY MANAGEMENT CO., LTD., Osaka (JP)

(21) Appl. No.: 17/598,978

(22) PCT Filed: Mar. 20, 2020
(86) PCT No.: PCT/JP2020/012553

§ 371 Date: Sep. 28, 2021

(30) Foreign Application Priority Data
Mar. 29, 2019 (JP) 2019-067372

(51) Int. Cl. G06Q 20/40; G06V 40/16

(52) U.S. Cl. CPC G06Q 20/40145; G06V 40/172; G06V 40/166

(57) ABSTRACT

An unstaffed store system includes: a store entry checker which acquires, with a first camera, a face image of a user at a time of entry to the store and permits entry of the user to the store based on the face image at the time of entry to the store; a checkout counter which acquires, with a second camera, the face image of the user at a time of payment and allows the user to make payment based on the face image at the time of payment; and a store exit checker which, with a third camera, acquires the face image of the user at a time of exit from the store and confirms exit of the user from the store based on the face image at the time of exit from the store.

### TECHNICAL FIELD

The present disclosure relates to an unstaffed store system and an unstaffed store management method for managing a status of use of an unstaffed store by a pre-registered user by means of face authentication.

### BACKGROUND ART

In recent years, retail stores, such as convenience stores and supermarkets, are increasingly equipped with cameras to capture images in the store for a variety of purposes. For example, a technology is known in which cameras are installed at appropriate positions along a movement path of a user from visiting to the store, selecting desired merchandise from display shelves, cost calculation and payment for the merchandise, to exiting from the store, so that the user can be identified by face authentication (see Patent Document 1).

### PRIOR ART DOCUMENT(S)

### Patent Document(s)

[Patent Document 1] JP6267674B2

### SUMMARY OF THE INVENTION

### Task to be Accomplished by the Invention

In the conventional technology, images of a user are captured by two cameras respectively installed near the entrance of the store and near the entrance of a payment area, and the face authentication is performed twice at the time of entry to the store and at the time of payment by using the face images acquired by the cameras. In the first face authentication at the time of entry to the store, it is identified which of the registered persons the user is, and this is registered in a database (visitor DB). In the second face authentication at the time of payment, it is identified which of the persons (visitors) registered in the database the user is. Thus, in the second face authentication at the time of payment, the persons to be matched are limited to the visitors, whereby the face authentication process can be performed quickly.

However, in the conventional technology, when multiple users simultaneously enter the payment area, the multiple users may appear in the images captured by the camera and multiple face images may be acquired at the same timing, and therefore, there are problems that when identifying the user who makes payment, false identification of the user may occur or that a user who exited the store without purchasing merchandise may be erroneously identified as the user who made the payment.

Thus, a primary object of the present disclosure is to provide an unstaffed store system and an unstaffed store management method which, in the face authentication in a store, can avoid false identification of users who purchased merchandise and can properly grasp users who exited the store without purchasing merchandise.

### Means to Accomplish the Task

An unstaffed store system of the present disclosure is an unstaffed store system for managing a status of use of an unstaffed store by pre-registered users by means of face authentication, comprising: a first face authentication machine configured to acquire, with a first camera, a face image of a user at a time of entry to the store and to perform a process related to face authentication for permitting entry of the user to the store based on the face image at the time of entry to the store; a second face authentication machine configured to acquire, with a second camera, the face image of the user at a time of payment and to perform a process related to face authentication for allowing the user to make payment based on the face image at the time of payment; and a third face authentication machine configured to acquire, with a third camera, the face image of the user at a time of exit from the store and to perform a process related to face authentication for confirming exit of the user from the store based on the face image at the time of exit from the store.

Also, an unstaffed store management method of the present disclosure is an unstaffed store management method for managing a status of use of an unstaffed store by pre-registered users by means of face authentication, comprising: a first face authentication step of acquiring, with a first camera, a face image of a user at a time of entry to the store and performing face authentication for permitting entry of the user to the store based on the face image at the time of entry to the store; a second face authentication step of acquiring, with a second camera, the face image of the user at a time of payment and performing face authentication for allowing the user to make payment based on the face image at the time of payment; and a third face authentication step of acquiring, with a third camera, the face image of the user at a time of exit from the store and performing face authentication for confirming exit of the user from the store based on the face image at the time of exit from the store.

### Effect of the Invention

According to the present disclosure, the users who purchased merchandise undergo face authentication at the time of entry to the store, at the time of payment, and at the time of exit from the store, while the users who exited the store without purchasing merchandise undergo face authentication at the time of entry to the store and at the time of exit from the store. Therefore, it is possible to accurately identify the users who purchased the merchandise and exited the store and also to accurately identify the users who exited the store without purchasing merchandise. Thereby, it is possible to avoid false identification of the users who purchased merchandise and to properly grasp the users who exited the store without purchasing merchandise.

### BRIEF DESCRIPTION OF THE DRAWINGS

FIG. 1 is an overall configuration diagram of an unstaffed store system according to the present embodiment;

FIG. 2 is a plan view showing a layout of the unstaffed store;

FIG. 3 is an overall perspective view of a checkout counter 2;

FIG. 4 is a perspective view showing an upper wall portion 34 as viewed from obliquely below;

FIG. 5 is a plan view showing a top plate portion 33 as viewed from above;

FIG. 6 is a block diagram showing a schematic configuration of the checkout counter 2;

FIG. 7 is a block diagram showing a schematic configuration of the store entry checker 1;

FIG. 8 is an explanatory diagram showing screens displayed on a display 82 of a store entry checker 1;

FIG. 9 is an explanatory diagram showing screens displayed on a touch panel display 42 of the checkout counter 2;

FIG. 10 is an explanatory diagram showing screens displayed on the touch panel display 42 of the checkout counter 2;

FIG. 11 is an explanatory diagram showing screens displayed on the touch panel display 42 of the checkout counter 2;

FIG. 12 is an explanatory diagram showing screens displayed on the touch panel display 42 of the checkout counter 2;

FIG. 13 is an explanatory diagram showing screens displayed on the touch panel display 42 of the checkout counter 2;

FIG. 14 is an explanatory diagram showing screens displayed on the touch panel display 42 of the checkout counter 2;

FIG. 15 is an explanatory diagram showing screens displayed on the touch panel display 42 of the checkout counter 2;

FIG. 16 is an explanatory diagram showing the hierarchical structure of the screens displayed on the touch panel display 42 of the checkout counter 2;

FIG. 17 is an explanatory diagram showing the hierarchical structure of the screens displayed on the touch panel display 42 of the checkout counter 2;

FIG. 18 is a flowchart showing an operating procedure of a user terminal 11 at the time of user registration;

FIG. 19 is a flowchart showing an operating procedure of the store entry checker 1;

FIG. 20 is a flowchart showing an operating procedure of the checkout counter 2;

FIG. 21 is a flowchart showing the operating procedure of the checkout counter 2;

FIG. 22 is a flowchart showing an operating procedure of a store exit checker 3;

FIG. 23 shows side views illustrating the checkout counter 2 according to modifications of the present embodiment;

FIG. 24 is an explanatory diagram showing configurations of the checkout counter 2 according to the modifications of the present embodiment;

FIG. 25 shows side views illustrating the checkout counter 2 according to other modifications of the present embodiment; and

FIG. 26 is an explanatory diagram showing configurations of the checkout counter 2 according to the other modifications of the present embodiment.

### MODES(S) FOR CARRYING OUT THE INVENTION

The first aspect of the invention made to solve the above problem provides an unstaffed store system for managing a status of use of an unstaffed store by pre-registered users by means of face authentication, comprising: a first face authentication machine configured to acquire, with a first camera, a face image of a user at a time of entry to the store and to perform a process related to face authentication for permitting entry of the user to the store based on the face image at the time of entry to the store; a second face authentication machine configured to acquire, with a second camera, the face image of the user at a time of payment and to perform a process related to face authentication for allowing the user to make payment based on the face image at the time of payment; and a third face authentication machine configured to acquire, with a third camera, the face image of the user at a time of exit from the store and to perform a process related to face authentication for confirming exit of the user from the store based on the face image at the time of exit from the store.

According to this, the users who purchased merchandise undergo face authentication at the time of entry to the store, at the time of payment and at the time of exit from the store, while the users who exited the store without purchasing merchandise undergo face authentication at the time of entry to the store and at the time of exit from the store. Therefore, it is possible to accurately identify the users who purchased the merchandise and exited the store and also to accurately identify the users who exited the store without purchasing merchandise. Thereby, it is possible to avoid false identification of the users who purchased merchandise and to properly grasp the users who exited the store without purchasing merchandise.

In the second aspect of the invention, the first camera is installed in a vicinity of a gate device so that the face of the user entering the store is included in an imaging area, and the first face authentication machine is configured to control opening and closing of the gate device according to a face authentication result.

According to this, the face image of the user at the time of entry to the store can be properly acquired. Also, it is possible to prevent persons other than the pre-registered users from entering the store.

In the third aspect of the invention, the system further comprises a display for displaying information related to cost calculation and face authentication, wherein the second camera is installed in a vicinity of the display such that the face of the user viewing the display is included in an imaging area.

According to this, it is possible to reliably capture an image of the user's face from the front.

In the fourth aspect of the invention, the second face authentication machine is a checkout counter with which the user performs an operation related to cost calculation and payment, and the third camera is installed such that the face of the user facing the checkout counter installed near an exit of the store is not included in an imaging area.

According to this, it is possible to ensure that the face of the user who is facing the checkout counter and performing an operation for the cost calculation and payment without need for installation of a concealment. Also, it is possible to reliably capture an image of the face of the user who finished the cost calculation and payment.

In the fifth aspect of the invention, the system further comprises: an information storage configured to accumulate information related to results of face authentication performed by the first to third face authentication machines; and an analysis device configured to generate analysis information of each user who visited the store according to purchase or non-purchase of merchandise.

According to this, the analysis information of each user who visited the store according to purchase or non-purchase of merchandise can be presented to a store manager or the like.

In the sixth aspect of the invention, the system further comprises a server device connected with the first face authentication machine, the second face authentication machine, and the third face authentication machine via a network, wherein the server device is configured to perform a face authentication process based on the face images respectively acquired from the first face authentication machine, the second face authentication machine, and the third face authentication machine.

According to this, since the face authentication is performed in the server device, it is possible to reduce the load on the face authentication machine. In addition, since the personal information for the face authentication is stored in the server device, it is possible to ensure security for privacy protection.

The seventh aspect of the invention provides an unstaffed store management method for managing a status of use of an unstaffed store by pre-registered users by means of face authentication, comprising: a first face authentication step of acquiring, with a first camera, a face image of a user at a time of entry to the store and performing face authentication for permitting entry of the user to the store based on the face image at the time of entry to the store; a second face authentication step of acquiring, with a second camera, the face image of the user at a time of payment and performing face authentication for allowing the user to make payment based on the face image at the time of payment; and a third face authentication step of acquiring, with a third camera, the face image of the user at a time of exit from the store and performing face authentication for confirming exit of the user from the store based on the face image at the time of exit from the store.

According to this, similarly to the first aspect of the invention, it is possible to avoid false identification of the users who purchased merchandise and to properly grasp the users who exited the store without purchasing merchandise.

In the following, embodiments of the present disclosure will be described with reference to the drawings.

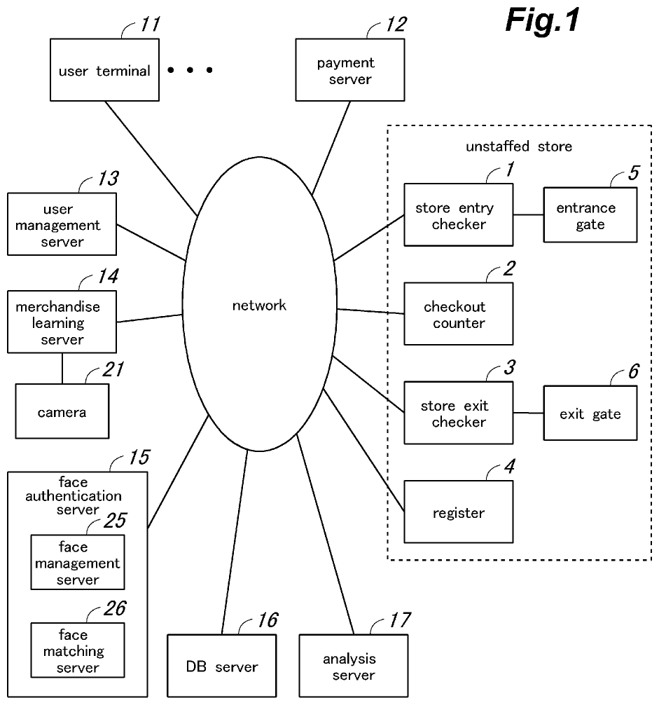

FIG. 1 is an overall configuration diagram of an unstaffed store system according to the present embodiment.

This unstaffed store system is for allowing a retail store, such as a convenience store or a supermarket, to be unstaffed or achieving a retail store in which there is no store clerk for performing cost calculation and receiving payment.

The unstaffed store is provided with a store entry checker 1 (first face authentication machine), a checkout counter 2 (cost calculation and payment device, second face authentication machine), a store exit checker 3 (third face authentication machine), and a register 4 (face registration machine).

Further, the unstaffed store system includes user terminals 11, a payment server 12, a user management server 13, a merchandise learning server 14, a face authentication server 15, a DB server 16 (information storage), and an analysis server 17 (analysis device).

The user terminals 11, the payment server 12, the user management server 13, the merchandise learning server 14, the face authentication server 15, the DB server 16, and the analysis server 17 as well as the store entry checker 1, the checkout counter 2, the store exit checker 3, and the register 4, which are provided in the unstaffed store, are connected to each other via a network such as the Internet and a LAN.

Note that the user management server 13, the merchandise learning server 14, the face authentication server 15, the DB server 16, and the analysis server 17 may be installed in the unstaffed store, for example, in a backyard annexed to the sales area, but may also be installed in places remote from the unstaffed store, for example, in the headquarters of a party operating the unstaffed store.

The store entry checker 1 performs a process related to face authentication for permitting entry of users to the store, and controls opening and closing of an entrance gate 5 (gate device) according to the face authentication result. In the present embodiment, password authentication is performed as a backup when the user cannot enter the store due to failure of face authentication.

The checkout counter 2 performs a process related to face authentication for cost calculation and payment (paying of the cost) of the merchandise the user has selected in the sales area of the unstaffed store. In the present embodiment, as a process related to the cost calculation, items of merchandise are identified by object recognition based on the captured images of the merchandise items (merchandise recognition process), and the total amount to be paid is calculated based on the price (unit price) and number of each merchandise item (cost calculation). Also, a request is made to the face authentication server 15 to perform a face authentication process as a process related to payment, and if the face authentication is successful, a request is made to the payment server 12 to perform a payment process.

The store exit checker 3 performs a process related to face authentication for confirming exit of the users from the store, and controls opening and closing of an exit gate 6 in accordance with the face authentication result.

The register 4 is a device with which the user performs an operation related to user registration (registration of member information and face image) necessary for the user to use the present system, and is constituted of a tablet terminal, for example, in which an application for user registration is installed.

Similarly to the register 4, the user terminal 11 is a device with which the user performs an operation related to user registration (registration of member information and face image) necessary for the user to use the present system and manages purchase history (receipt information), and is constituted of a smartphone or a tablet terminal in which a user application is installed.

The payment server 12 is a server run by a payment service company (a credit company or the like). This payment server 12 executes, in response to the payment request from the checkout counter 2, the payment process related to the cost of the merchandise purchased by the user. Note that the payment server 12 may be a server run by a payment agency company (payment agency server).

The user management server 13 functions as a login server that manages the login of the users and performs password authentication. Also, the user management server 13 functions as a payment interface server that interfaces between the checkout counter 2 and the payment server 12.

Also, the user management server 13 manages a store visitor list related to the users visiting the store (the users staying in the store). The store visitor list can be generated based on the users entering the store, namely, the users acquired by the face authentication at the time of entry to the store performed by the store entry checker 1, and the users exiting the store, namely, the users acquired by the face authentication at the time of exit from the store performed by the store exit checker 3.

The merchandise learning server 14 constructs a merchandise recognition engine, which is installed in the checkout counter 2, through machine learning such as deep learning. In this merchandise learning server 14, machine learning is conducted with the merchandise images acquired beforehand by capturing the images of the merchandise items to be registered being input information and the feature information of each merchandise item being output information, thereby constructing a database for merchandise recognition.

The face authentication server 15 includes a face management server 25 and a face matching server 26. The face management server 25 accumulates and manages the information, such as the name and face information (face ID, face image), of the registered users. The face matching server 26 performs face authentication in response to a request for face authentication from the store entry checker 1, the checkout counter 2, and the store exit checker 3. In this face authentication, the face matching server 26 acquires the face image of the user in question from the store entry checker 1, the checkout counter 2, and the store exit checker 3, generates the facial features of the user in question from the face image, and performs face matching by comparing the facial features of the user in question with the facial features of the registrants (registered users) stored in the own device, thereby to determine whether the user in question is one of the registrants (1-to-N authentication). Note that it is also possible to acquire the store visitor list managed by the user management server 13 and to perform the face authentication after narrowing down the registrants to the store visitors.

The DB server 16 accumulates and manages various information. Specifically, as user management information, information such as the payment ID, face ID, user ID, password, and office code of each user is registered in the database. Also, as merchandise master information, information such as identification information of each merchandise (merchandise name, merchandise code, etc.) is registered in the database. Further, as purchase log information, information such as the user ID of each user and the name and price of each merchandise item purchased by the user is registered in the database.

The analysis server 17 performs various analysis processes based on the information accumulated in the DB server 16. Specifically, the analysis server 17 performs an analysis process according to purchase or non-purchase of merchandise by each user who visited the store. For example, the analysis server 17 calculates the ratio between the purchasers and non-purchasers according to a prescribed criteria (by day of the week, time zone, etc.).

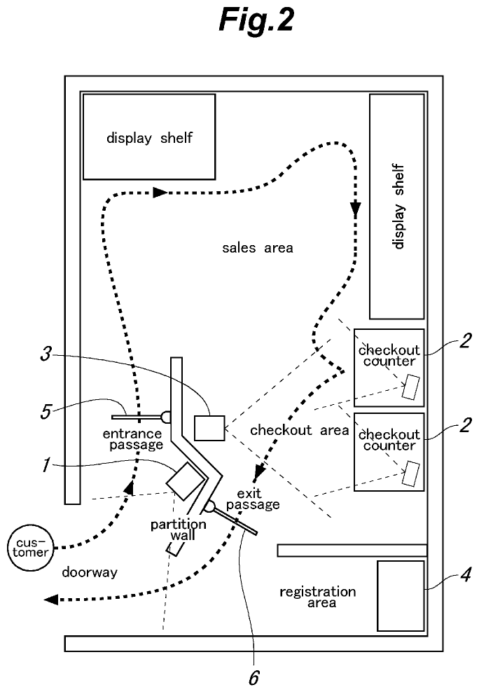

Next, a description will be made of the unstaffed store. FIG. 2 is a plan view showing the layout of the unstaffed store.

The unstaffed store is provided with a doorway, a sales area, a checkout area, and a registration area. In the vicinity of the doorway, an entrance passage and an exit passage separated by a partition wall are provided. Display shelves are set up in the sales area. The registration area is provided in a position adjacent to the checkout area and directly accessible from the doorway.

The store entry checker 1 is installed in the vicinity of the doorway to capture images of the doorway from inside. The entrance gate 5 is installed to close the entrance passage. The store exit checker 3 is install to face the checkout counters 2. The exit gate 6 is installed to close the exit passage. In the checkout area, multiple checkout counters 2 are installed. In the registration area, the register 4 is installed.

When the user enters the store through the doorway, the store entry checker 1 captures an image of the user's face and performs face authentication, and if the face authentication is successful, the entrance gate 5 opens so that the user can enter the sales area. Then, the user examines the merchandise items on the display shelves in the sales area and picks up merchandise items to purchase from the display shelves. Subsequently, the user moves to the checkout area and performs an operation for cost calculation and payment at the checkout counter 2. At this time, upon placement of the merchandise items selected by the user on the checkout counter 2, the cost calculation is performed, and then the face authentication and the password authentication are performed. If the face authentication and the password authentication are successful, payment is executed. Note that in this payment process, password authentication may be omitted. Thereafter, the user moves to the exit passage to exit from the store. At this time, the store exit checker 3 captures an image of the user's face and performs face authentication, and if the face authentication is successful, the exit gate 6 opens so that the user can exit from the store through the doorway.

Here, the store exit checker 3 captures an image of the user's face at a timing when the user who finished the cost calculation and payment turns around. Thereby, it is possible to capture an image of the face of only the user who finished the cost calculation and payment from the front.

Note that if the store exit checker 3 were installed such that an image of a person moving toward the exit gate 6 can be captured from the front, all persons moving from the far side of the store toward the doorway would show up in the captured image, and thus, the captured image would be in an inappropriate state in which many persons other than the person exiting the store are included. Also, for a person exiting the store without checkout, an image of the face will be captured in an oblique direction, and when the face authentication fails at the store exit checker 3 and the exit gate 6 does not open, it would be preferred to guide the user with voice or the like to have an image of the face captured from the front at the store exit checker 3.

Note that in the present embodiment, description is made with regard to the unstaffed store, but a form including the features of both an unstaffed store and a staffed store may also be possible. For example, both an unstaffed cash register and a staffed cash register may be installed in a single store. Also, a single store may be divided into an unstaffed area and a staffed area.

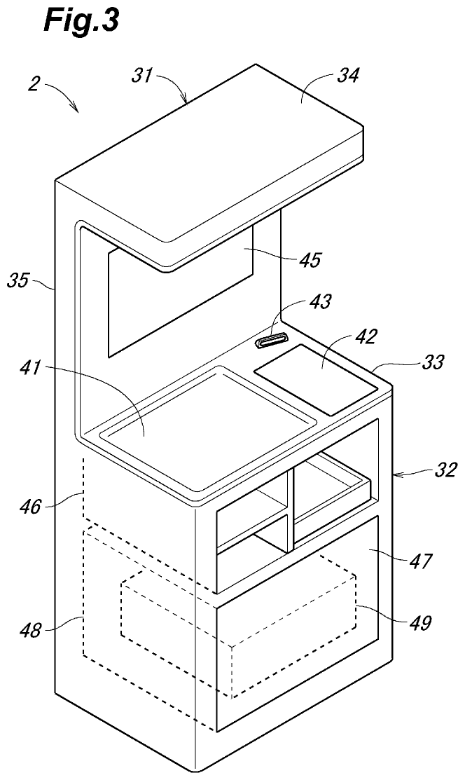

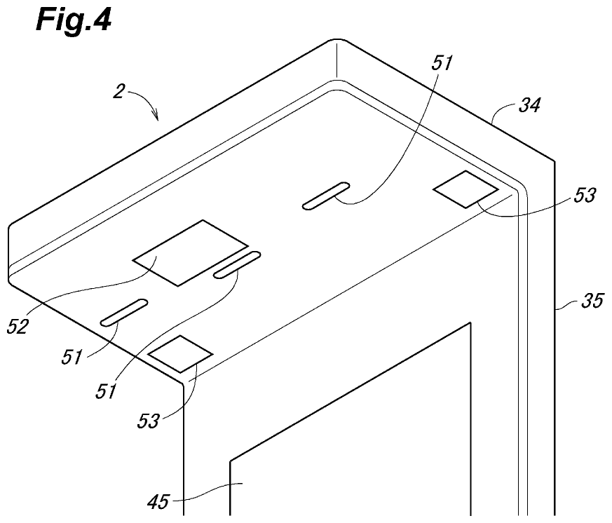

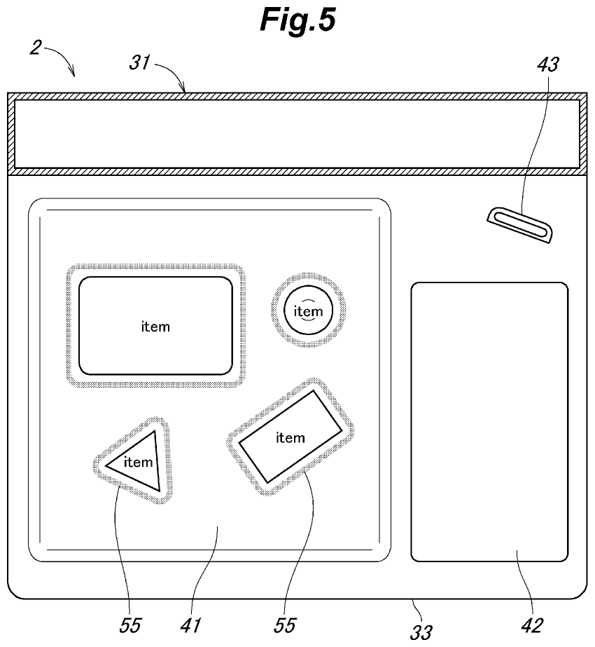

Next, a description will be made of the checkout counter 2. FIG. 3 is an overall perspective view of the checkout counter 2. FIG. 4 is a perspective view showing an upper wall portion 34 as viewed from obliquely below. FIG. 5 is a plan view showing a top plate portion 33 from above.

As shown in FIG. 3, a main body 31 of the checkout counter 2 includes a box-shaped portion 32, a top plate portion 33, an upper wall portion 34, and a rear wall portion 35. The top plate portion 33 is provided on an upper side of the box-shaped portion 32. The rear wall portion 35 is provided to protrude upward from a rear side of the box-shaped portion 32. The upper wall portion 34 is provided to protrude forward from an upper end of the rear wall portion 35 like eaves.

The top plate portion 33 is provided with a placement portion 41 on which the user places the merchandise items to purchase (the merchandise items selected in the sales area). With the user simply placing the merchandise items side by side on the placement portion 41, the placed merchandise items are identified by object recognition, and cost calculation, or calculation of the amount of money to be paid, is performed based on the unit price of each merchandise item. Note that the placement portion 41 is recessed in a dish shape so that the user can easily understand the range within which the merchandise items should be placed.

In addition, the top plate portion 33 is provided with a touch panel display 42. The touch panel display 42 displays the merchandise recognition result, namely, the merchandise items for which the cost calculation is executed, and when there is no error in the merchandise recognition result, the user can perform an operation related to face authentication and password authentication. Also, when there is an error in the merchandise recognition result, the user can perform an operation for correcting the merchandise items for which the cost calculation is executed.

Also, the top plate portion 33 is provided with a camera 43. This camera 43 is installed in the vicinity of the touch panel display 42, and therefore, can capture an image of the face of the user viewing the touch panel display 42 from the front. The face image acquired by the camera 43 is used for the purpose of face authentication for payment.

The box-shaped portion 32 is provided with a first storing part 46 (rack) having an open front side and a second storing part 48 having a front side closed by a door 47. In the first storing part 46, accessory items of merchandise are stored. These accessory items are provided to the users for free and the users can take them home freely. Specifically, the accessory items include shopping bags, cutleries (spoons, forks, etc.) and the like. In the second storing part 48, a controller 49 (PC) for controlling the touch panel display 42 and the camera 43 is stored.

Note that the open front side of the first storing part 46 may be formed to be slanted such that the inside of the first storing part 46 is visible. Thereby, the user can easily view the shopping bags and the cutleries stored in the storing part from obliquely above.

The rear wall portion 35 is provided with a display 45. This display 45 functions as a digital signage, and displays content such as a store guide or advertisement of merchandise at all times.

As shown in FIG. 4, the upper wall portion 34 is provided with cameras 51. These cameras 51 capture images of the merchandise items placed on the placement portion 41 of the top plate portion 33. Here, three cameras 51 are provided. The central camera 51 captures images of the merchandise items placed on the placement portion 41 from directly above, and the captured images are used for the purpose of detecting the positions of the merchandise items placed on the placement portion 41. The two cameras 51 on respective sides capture images of the merchandise items placed on the placement portion 41 from obliquely above, and the captured images are used for the purpose of recognizing the merchandise items (merchandise names) placed on the placement portion 41.

Also, the upper wall portion 34 is provided with a projector 52. The projector 52 is for performing projection mapping on the placement portion 41, on which the merchandise items are to be placed, and projects a prescribed image onto the placement portion 41 from directly above. In the present embodiment, as shown in FIG. 5, the projector 52 projects frame images 55 surrounding the respective merchandise items placed on the placement portion 41. Particularly, the projector 52 projects the frame images 55 to surround the respective merchandise items for which the merchandise recognition was successful. Thereby, it is possible to let the user know the merchandise items for which the merchandise recognition was successful, and the user can reset or rearrange only the merchandise items that could not be recognized.

Also, as shown in FIG. 4, speakers 53 are provided on the upper wall portion 34. The speakers 53 output voices for responding to the users entering the store.

Incidentally, of the three the cameras 51 provided on the upper wall portion 34, the central camera 51 is provided to capture an image from directly above the placement portion 41, such that it is possible to accurately detect the positions of the merchandise items on the placement portion 41. Therefore, the projector 52 can project the frame images 55 at appropriate positions based on the highly accurate position information. Also, the projector 52 is provided to project from directly above the placement portion 41, namely, to project directly downward such that the optical axis extends in the vertical direction, whereby it is possible to project sharp images.

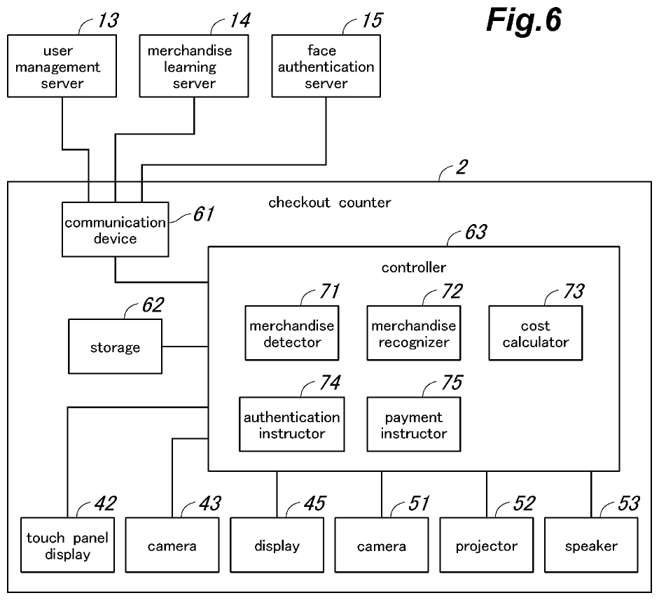

Next, a description will be made of a schematic configuration of the checkout counter 2. FIG. 6 is a block diagram showing a schematic configuration of the checkout counter 2.

The checkout counter 2 is provided with a touch panel display 42, a camera 43, a display 45, cameras 51, a projector 52, speakers 53, a communication device 61, a storage 62, and a controller 63.

The touch panel display 42 and the camera 43 are provided on the top plate portion 33, while the display 45 is provided on the rear wall portion 35 (see FIG. 3). The cameras 51, the projector 52, and the speakers 53 are provided on the upper wall portion 34 (see FIG. 4).

The communication device 61 communicates with the user management server 13, the merchandise learning server 14, and the face authentication server 15 via a network.

The storage 62 stores programs executed by the processor constituting the controller 63. Also, the storage 62 stores the merchandise master information. Specifically, the storage 62 stores identification information of the merchandise items (the merchandise name, merchandise code, etc.), information used in the merchandise recognition process (namely, the feature information of each merchandise item), information used in the cost calculation (namely, information related to the price of each merchandise item (unit price)), etc.

The controller 63 includes a merchandise detector 71, a merchandise recognizer 72, a cost calculator 73, an authentication instructor 74, and a payment instructor 75. This controller 63 is constituted of a processor and each functional unit of the controller 63 is realized by executing the programs stored in the storage 62 by the processor.

The merchandise detector 71 detects placement of merchandise items on the placement portion 41 based on the images captured by the cameras 51 arranged to capture images of the placement portion 41. Also, when merchandise items are placed on the placement portion 41, the merchandise detector 71 detects the positions of the merchandise items based on the images captured by the cameras 51.

The merchandise recognizer 72 recognizes the merchandise items placed on the placement portion 41 based on the images captured by the cameras 51. In the present embodiment, the merchandise recognizer 72 uses the merchandise recognition engine constructed through machine learning such as deep learning to extract the feature information from each merchandise image cut out from the captured image, and compares the feature information with the feature information of each merchandise item registered beforehand, thereby to acquire a recognition result such as a degree of similarity.

The cost calculator 73 calculates the cost of the merchandise items placed on the placement portion 41. Namely, the cost calculator 73 acquires the price (unit price) of each merchandise item placed on the placement portion 41 and aggregates the prices of the merchandise items, thereby to calculate the total amount to be paid.

The authentication instructor 74 instructs the face authentication server 15 to perform face authentication and the user management server 13 to perform password authentication, as authentication for payment. In the present embodiment, two-factor authentication consisting of the face authentication and the password authentication is adopted to enhance security, and payment is permitted when both the face authentication and the password authentication are successful. Note that in the face authentication, a face image is cut out from the image captured by the camera 43, and the face image is transmitted to the face authentication server 15. Also, in the password authentication, the user ID and the password entered by the user are transmitted to the user management server 13.

The payment instructor 75 instructs the payment server 12 to perform a payment process.

Note that, besides the above, the controller 63 of the checkout counter 2 performs a process of controlling the projector 52 based on the position information of the merchandise items acquired by the merchandise detector 71 to project the frame images 55 onto the placement portion 41 (projection mapping) and a process of controlling the display 45 to make the display 45 display contents for digital signage. At this time, the content data is stored beforehand in the storage 62 or received from the outside (such as a content delivery server).

Note that in the present embodiment, the merchandise recognition process was performed in the checkout counter 2, but the merchandise recognition process may be performed in an external server.

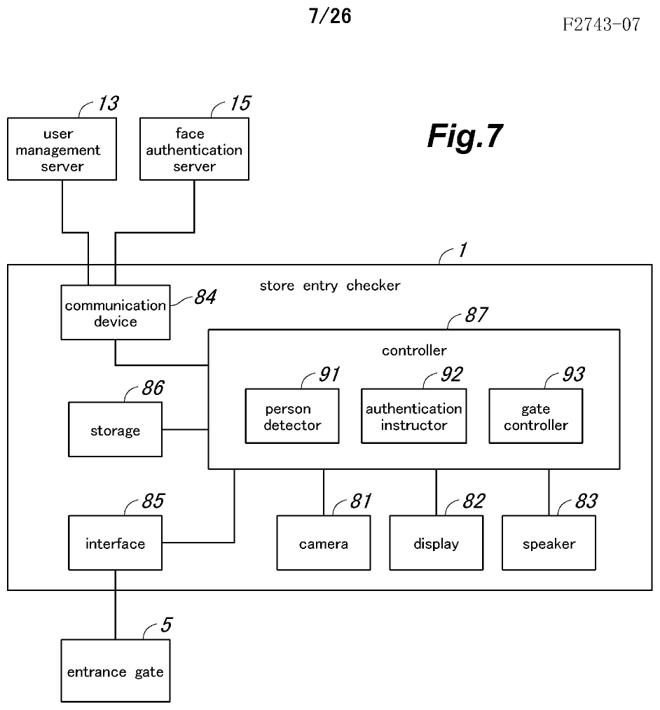

Next, a description will be made of a schematic configuration of the store entry checker 1. FIG. 7 is a block diagram showing a schematic configuration of the store entry checker 1.

The store entry checker 1 includes a camera 81, a display 82, a speaker 83, a communication device 84, an interface 85, a storage 86, and a controller 87.

The camera 81 captures images of the doorway from inside to acquire captured images including the faces of the users entering the store.

The display 82 displays a screen for responding to the users entering the store.

The speaker 83 outputs voices for responding to the users entering the store.

The communication device 84 communicates with the user management server 13 and the face authentication server 15 via a network.

The interface 85 allows control signals to be input and output from and to the entrance gate 5.

The storage 86 stores programs executed by a processor constituting the controller 87.

The controller 87 includes a person detector 91, an authentication instructor 92, and a gate controller 93. This controller 87 is constituted of a processor and each functional unit of the controller 87 is realized by executing the programs stored in the storage 86 by the processor.

The person detector 91 detects entry of persons to the store based on the images captured by the camera 81 arranged to capture images of the doorway.

The authentication instructor 92 instructs the face authentication server 15 to perform face authentication as authentication for entry to the store. In the present embodiment, the authentication instructor 92 instructs execution of password authentication as a backup when the user cannot enter the store due to failure of face authentication.

The gate controller 93 controls opening and closing of the entrance gate 5 via the interface 85 in accordance with the result of the face authentication or the password authentication.

Note that the configuration of the store exit checker 3 is substantially the same as the store entry checker 1.

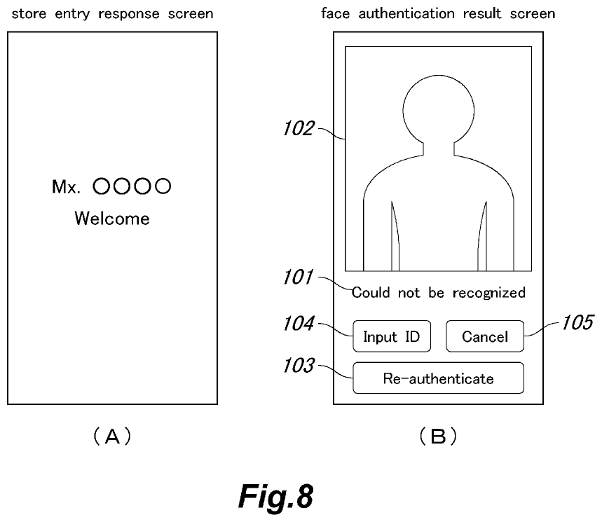

Next, a description will be made of the screens displayed on the display 82 of the store entry checker 1. FIG. 8 is an explanatory diagram showing screens displayed on the display 82 of the store entry checker 1.

Upon detection of a person entering the store, the store entry checker 1 extracts a face image of the store visitor from the image captured by the camera 81, and makes the face authentication server 15 perform face authentication based on the face image, and if the face authentication is successful, displays a store entry response screen shown in FIG. 7(A) on the display 82.

On the other hand, when the face authentication fails, a face authentication result screen shown in FIG. 7(B) is displayed on the display 82. In this face authentication result screen, a message 101 indicating that the face authentication failed (“Could not be recognized”) is displayed together with the face image of the store visitor 102, a “Re-authenticate” button 103, an “Input ID” button 104, and a “Cancel” button 105.

Note that similarly to the store entry checker 1, the store exit checker 3 makes the face authentication server 15 perform face authentication based on the face image of the person extracted from the captured image, and if the face authentication is successful, displays a store exit response screen on the display.

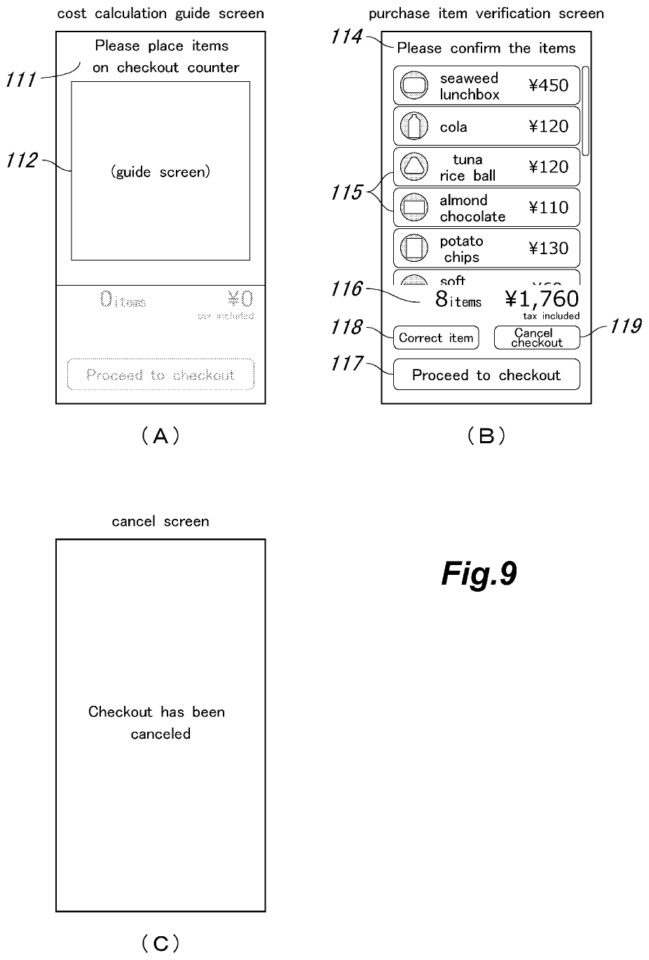

Next, a description will be made of the screens displayed on the touch panel display 42 of the checkout counter 2. FIGS. 9 to 15 are explanatory diagrams showing the screens displayed on the touch panel display 42 of the checkout counter 2.

The touch panel display 42 of the checkout counter 2 first displays a cost calculation guide screen shown in FIG. 9(A). This cost calculation guide screen displays a guide message 111 prompting the user to place the merchandise items on the placement portion 41 of the checkout counter 2 and a guide image 112 (illustration or the like) for explaining how to place the merchandise items. Here, when the user places the merchandise items on the placement portion 41, processes of merchandise recognition and cost calculation are performed at the checkout counter 2, and the screen transitions to a purchase item verification screen (see FIG. 9(B)).

In the purchase item verification screen shown in FIG. 9(B), a guide message 114 for prompting the user to confirm the merchandise items and item boxes 115 (item display portions) indicating the name and price of the respective merchandise items are displayed. The item boxes 115 relate to the merchandise items placed on the placement portion 41 by the user, particularly the merchandise items recognized by the merchandise recognition, and multiple item boxes 115 are displayed side by side.

Also, the purchase item verification screen is provided with a cost calculation result display portion 116. In this cost calculation result display portion 116, the cost calculation result, namely, the total number of the merchandise items placed on the placement portion 41 and the total amount of money thereof are displayed.

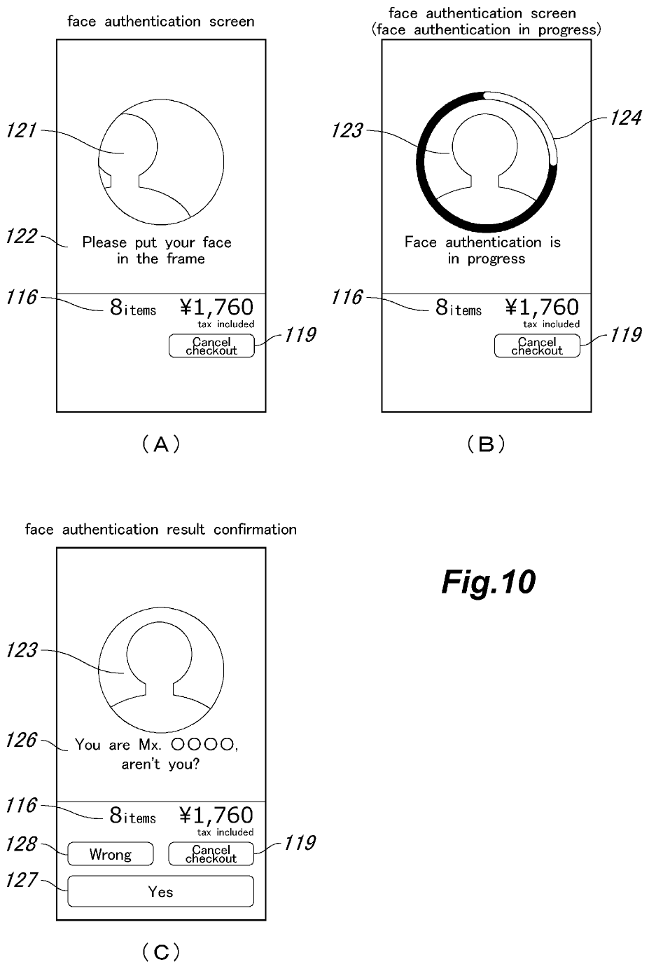

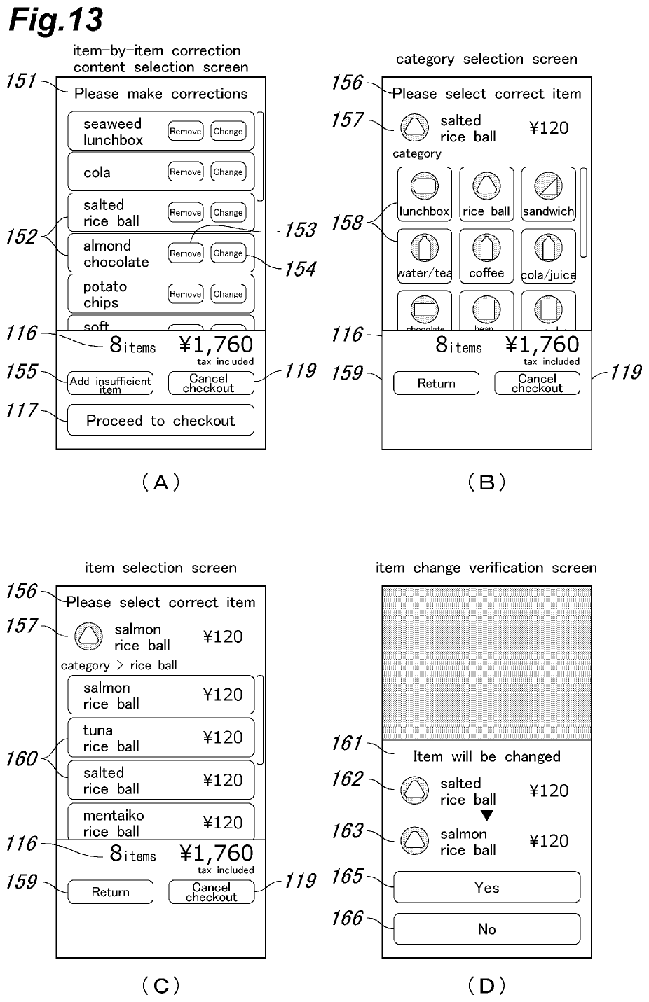

Further, the purchase item verification screen is provided with a “Proceed to checkout” button 117, a “Correct item” button 118, and a “Cancel checkout” button 119. Here, when the “Proceed to checkout” button 117 is operated, the screen transitions to a face authentication screen (see FIG. 10(A)). On the other hand, when the “Correct item” button 118 is operated, the screen transitions to an item-by-item correction content selection screen (see FIG. 13(A)). Further, when the “Cancel checkout” button 119 is operated, the screen transitions to a cancel screen (see FIG. 9(C)). When a merchandise items are removed from the placement portion 41 also, the screen transitions to the cancel screen.

In the face authentication screen shown in FIG. 10(A), a captured image 121 of the user and a message 122 prompting adjustment of the position of the face of the user when the face is not positioned in a predetermined imaging area are displayed. Here, the user adjusts position of his/her own face while viewing the captured image 121 of him/herself displayed on the screen, and when the image of the face is properly captured, the face image is transmitted to the face authentication server 15 so that the face authentication is started. At this time, the screen transitions to the face authentication screen during face authentication (see FIG. 10(B)).

In the face authentication screen shown in FIG. 10(B), a face image 123 extracted from the captured image of the user and a preloader 124 which visually indicates the progress of the face authentication are displayed. The cost calculation result display portion 116 and the “Cancel checkout” button 119 are the same as in the purchase item verification screen (see FIG. 9(B)).

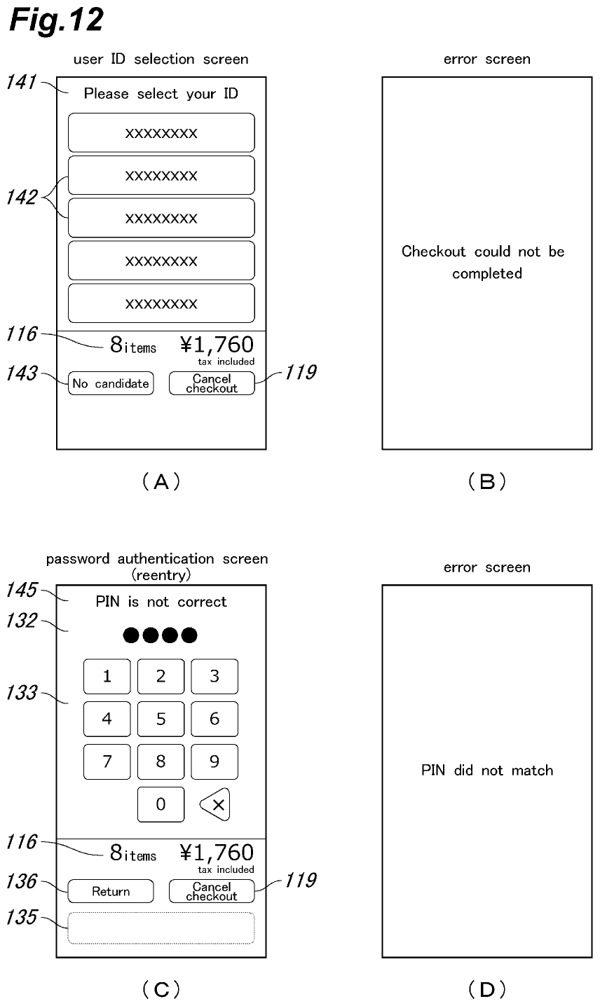

Here, when the face authentication is successful, the screen transitions to a face authentication result confirmation screen (see FIG. 10(C)). On the other hand, when the face authentication fails, the face image is acquired again and the face authentication is repeated a predetermined number of times, and if the face authentication fails consecutively for a predetermined number of times, the face authentication is canceled and it transitions to a mode in which payment may be made with only password authentication, and the screen transitions to a user ID selection screen (see FIG. 12(A)).

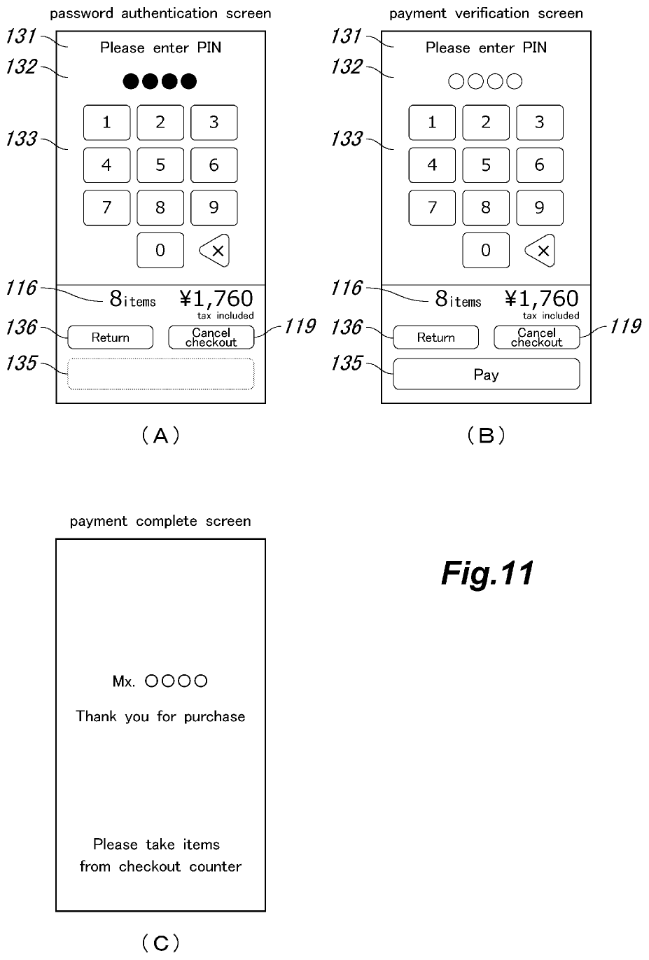

In the face authentication result confirmation screen shown in FIG. 10(C), the face image 123 of the user and a message 126 inquiring whether the user's name is correct are displayed. Also, the face authentication result confirmation screen is provided with a “Yes” button 127 and a “Wrong” button 128. Here, when the “Yes” button 127 is operated, the screen transitions to a password authentication screen (see FIG. 11(A)). When the “Wrong” button 128 is operated, the screen transitions to the user ID selection screen (see FIG. 12(A)).

Note that the cost calculation result display portion 116 and the “Cancel checkout” button 119 displayed in the screens shown in FIGS. 10(A), (B), and (C) are the same as in the purchase item verification screen (see FIG. 9(B)).

The password authentication screen shown in FIG. 11(A) includes a message 131 prompting entry of a PIN (personal identification number) as a password, an image 132 representing an entry status of the PIN, and a numeric keypad 133. Here, when the entry of a PIN with a prescribed number of digits is finished, password authentication is executed, and if the password authentication is successful, the screen transitions to a payment verification screen (see FIG. 11(B)). On the other hand, when the password authentication fails, the screen transitions to a password reentry screen (see FIG. 12(C)).

Also, the password authentication screen is provided with a “Pay” button 135 and a “Return” button 136. Here, when the “Return” button 136 is operated, the screen returns to a state in which the PIN has not been entered yet. The “Pay” button 135 is grayed out and not operable.

In the payment verification screen FIG. 11(B), the “Pay” button 135 becomes operable, and if the “Pay” button 135 is operated, the screen transitions to a payment complete screen (see FIG. 11(C)).

Note that the cost calculation result display portion 116 and the “Cancel checkout” button 119 the displayed in the screen shown in FIGS. 11(A) and (B) are the same as in the purchase item verification screen (see FIG. 9(B)).

The user ID selection screen shown in FIG. 12(A) includes a message 141 prompting the user to select his/her user ID and user ID buttons 142. The user ID buttons 142 correspond to the respective users registered in the store visitor list, and multiple buttons 142 are displayed side by side. Further, the user ID selection screen is provided with a “No candidate” button 143. Here, when the user operates his/her own user ID button 142, the screen transitions to a password authentication screen (see FIG. 11(A)). When the user operates the “No candidate” button 143, the screen transitions to a not-payable error screen (see FIG. 12(B)).

In the password reentry screen shown in FIG. 12(C), a message 145 indicating that the PIN is incorrect is displayed. The other features are the same as those of the password authentication screen (see FIG. 11(A)). Here, the user reenters the password, and if the password authentication is successful, the screen transitions to the payment verification screen (see FIG. 11(B)). On the other hand, if the password authentication fails again, the screen transitions to an incorrect-password error screen (see FIG. 12(D)).

Note that the cost calculation result display portion 116 and the “Cancel checkout” button 119 displayed in the screens shown in FIGS. 12(A) and (C) are the same as in the purchase item verification screen (see FIG. 9(B)).

The item-by-item correction content selection screen shown in FIG. 13(A) includes a message 151 prompting a correcting operation and item boxes 152. The item boxes 152 are provided for the respective merchandise items identified by the merchandise recognition as the items for which the cost calculation is executed, and the multiple item boxes 152 are displayed side by side. These item boxes 152 correspond to the item boxes 115 of the purchase item verification screen (see FIG. 9(B)).

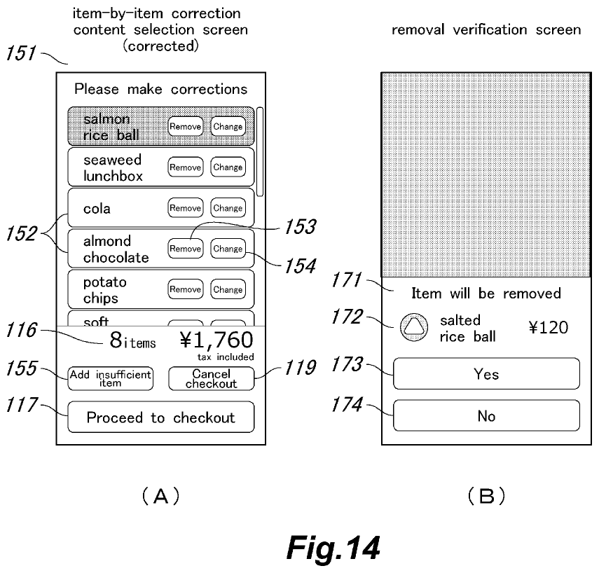

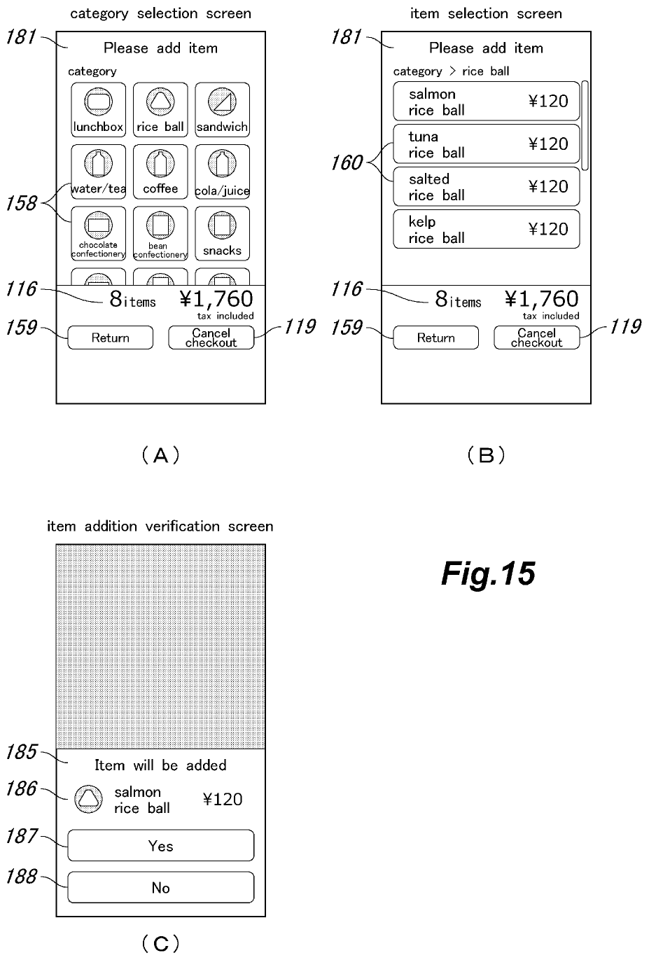

Each item box 152 is provided with a “Remove” button 153 and a “Change” button 154. Also, the item-by-item correction content selection screen is provided with an “Add insufficient item” button 155. Here, when the “Remove” button 153 is operated, the screen transitions to a removal verification screen (see FIG. 14(B)). When the “Change” button 154 is operated, the screen transitions to a category selection screen at the time of merchandise item change (see FIG. 13(B)). Also, when the “Add insufficient item” button 155 is operated, the screen transitions to a category selection screen at the time of merchandise item addition (see FIG. 15(A)).

The category selection screen at the time of merchandise item change shown in FIG. 13(B) includes a message 156 prompting selection of a merchandise item (category), a to-be-changed item display portion 157 displaying the information (name and price) of the merchandise item to be changed, and buttons 158 corresponding to respective categories. Also, this category selection screen is provided with a “Return” button 159. Here, when one category button 158 is operated, the screen transitions to an item selection screen for merchandise item change (see FIG. 13(C)). Also, when the “Return” button 159 is operated, the screen returns to the previous screen, namely, the item-by-item correction content selection screen (see FIG. 13(A)).

The item selection screen at the time of merchandise item change shown in FIG. 13(C) is provided with buttons 160 corresponding to the respective merchandise items included in the category selected with the category selection screen (see FIG. 13(B)). Here, when one merchandise item button 160 is operated, the screen transitions to a change verification screen (see FIG. 13(D)). Note that the message 156, the to-be-changed item display portion 157, and the “Return” button 159 are the same as in the category selection screen (see FIG. 13(B)).

The item change verification screen shown in FIG. 13(D) includes a message 161 indicating that the merchandise item change will be executed, a pre-change item display portion 162 displaying the information (name and price) of the merchandise item before change, and a post-change item display portion 163 displaying the information (name and price) of the merchandise item after change. Also, this change verification screen is provided with a “Yes” button 165 and a “No” button 166. Here, when the “Yes” button 165 is operated, the screen transitions to a corrected item-by-item correction content selection screen (see FIG. 14(A)). Also, when the “No” button 166 is operated, the screen returns to the item selection screen for merchandise item change (see FIG. 13(C)).

The corrected item-by-item correction content selection screen shown in FIG. 14(A) is approximately the same as the item-by-item correction content selection screen (see FIG. 13(A)), but here, the item box 152 related to the changed merchandise item is displayed first (at the uppermost portion) and is highlighted with a color different from the other item boxes 152.

Note that the cost calculation result display portion 116 and the “Cancel checkout” button 119 displayed in the screens shown in FIGS. 13(A), (B), and (C) are the same as in the purchase item verification screen (see FIG. 9(B)).

The removal verification screen FIG. 14(B) includes a message 171 indicating that a merchandise item will be removed and a removed item display portion 172 displaying the information (name and price) of the merchandise item to be removed. Also, this change verification screen is provided with a “Yes” button 173 and a “No” button 174. Here, when the “Yes” button 173 is operated, the screen transitions to a corrected item-by-item correction content selection screen (not shown in the drawings). This corrected item-by-item correction content selection screen is approximately the same as the item-by-item correction content selection screen shown in FIG. 14(A), but in the corrected item-by-item correction content selection screen at this time, the item boxes 152 are displayed to reflect the removal operation.

The category selection screen at the time of merchandise item addition shown in FIG. 15(A) is approximately the same as the category selection screen at the time of merchandise item change (see FIG. 13(B)), but here, a message 181 prompting selection of a merchandise item (category) to be added is displayed. When one category button 158 is operated, the screen transitions to a to-be-added item selection screen (see FIG. 15(B)).

The item selection screen at the time of merchandise item addition shown in FIG. 15(B) is approximately the same as the item selection screen at the time of merchandise item change (see FIG. 13(C)), but here, buttons 160 corresponding to the respective merchandise items included in the category selected with the category selection screen (see FIG. 15(A)) are displayed. When one merchandise item button 160 is operated, the screen transitions to an item addition verification screen (see FIG. 15(C)).

The item addition verification screen shown in FIG. 15(C) includes a message 185 that the merchandise item is to be added, and an added item display portion 186 for displaying the information (name and price) of the added merchandise item. Also, this addition verification screen is provided with a “Yes” button 187 and a “No” button 188. Here, when the “Yes” button 187 is operated, the screen transitions to the corrected item-by-item correction content selection screen (not shown in the drawings). When the “No” button 188 is operated, the screen returns to the to-be-added item selection screen (see FIG. 15(B)).

Note that the cost calculation result display portion 116 and the “Cancel checkout” button 119 displayed in the screens shown in FIGS. 15(A) and (B) are the same as in the purchase item verification screen (see FIG. 9(B)).

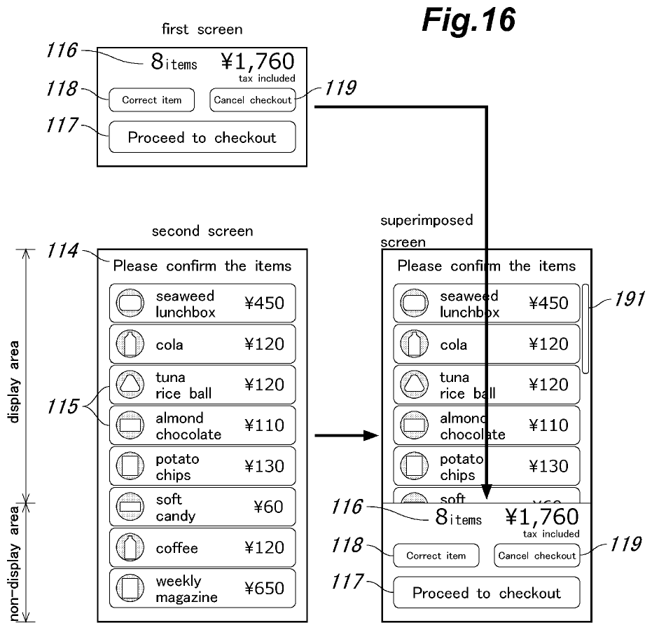

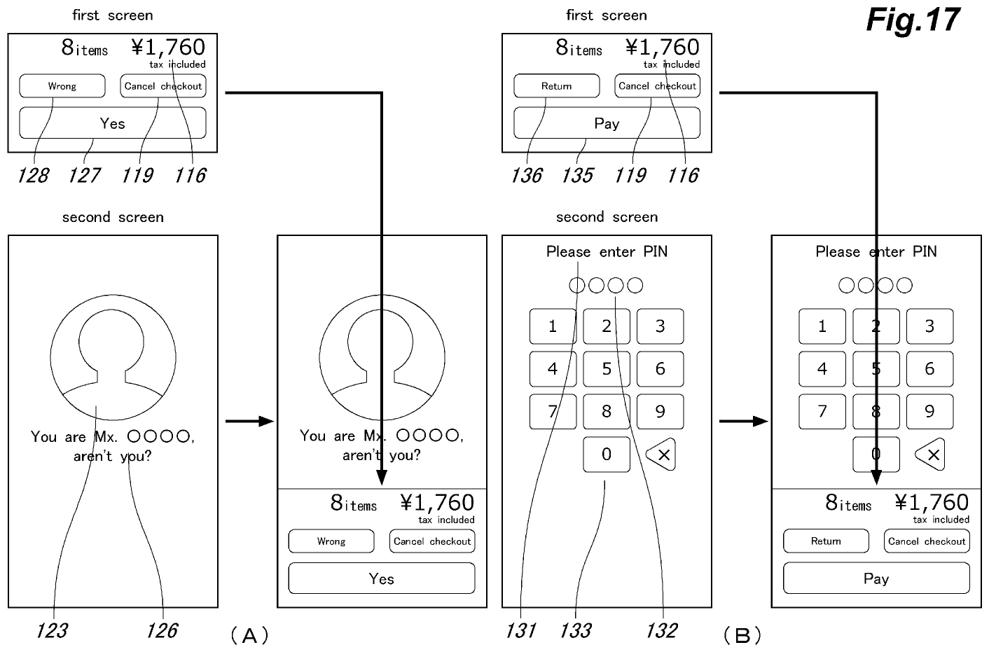

Next, a description will be made of a hierarchical structure of the screens displayed on the touch panel display 42 of the checkout counter 2. FIGS. 16 and 17 are explanatory diagrams showing the hierarchical structure of the screens displayed on the touch panel display 42 of the checkout counter 2.

As shown in FIG. 16, the screens displayed on the touch panel display 42 of the checkout counter 2 have a hierarchical structure in which multiple screens (layers) are superimposed (superimposed screen). In the present embodiment, two screens, namely, a first screen (front layer) disposed on the front side and a second screen (rear layer) disposed on the rear side are superimposed. Also, the first screen is displayed in a lower portion of the display area of the touch panel display 42, while the second screen is displayed over the entirety of the display area of the touch panel display 42. Therefore, a lower part of the second screen is covered by the first screen.

The first screen displays information of high importance and information that has been confirmed and enables the user to perform operations of high importance. On the other hand, the second screen displays a breakdown of the information displayed in the first screen and information based on which operations should be performed and enables the user to perform operations of relatively low importance. Since the user tends to view the screen from the upper side to the lower side, the user will first view a part of the second screen positioned on the upper side and lastly view the first screen and performs operations of high importance.

Here, an example shown in FIG. 16 illustrates a case of the purchase item verification screen (see FIG. 9(B)). In this case, the first screen presents to the user the information related to the cost calculation result (total amount of money) obtained by aggregating the prices of the merchandise items to purchase (the cost calculation result display portion 116). With this first screen, the user can confirm the cost calculation result. The second screen presents to the user cost calculation detail information (cost calculation breakdown information) related to the price of each merchandise item to purchase (the item boxes 115). With this second screen, the user can confirm whether the cost calculation is correct. Note that the cost calculation result (the cost calculation result display portion 116) displayed in the first screen continues to be displayed after the process proceeds to face authentication (see FIG. 10, etc.).

Also, the first screen is provided with the “Proceed to checkout” button 117 and the “Cancel checkout” button 119 as an operation part with which the user selects whether to approve the cost calculation result. Therefore, the user can confirm the cost calculation details with the second screen and the cost calculation result with the first screen, and if no error is found in the cost calculation, can perform an operation to approve the cost calculation result with the first screen.

Further, in the second screen, the item boxes 115 (item display portions), each showing the name and price of a merchandise item, are arranged side by side for the respective merchandise items selected by the user. On the other hand, the lower part of the second screen is partially covered by the first screen to form a non-display area. As a result, in a case where the number of merchandise items to purchase exceeds a prescribed value, some item boxes 115 appear in the non-display area of the second screen also. In this case, the item boxes 115 in the non-display area are covered by the first screen and hidden from view.

Therefore, in the present embodiment, the second screen is provided with a scroll bar 191 (scroll instruction part) for moving the item boxes 115 from the non-display area hidden behind the first screen to the display area on the outside (upper side) of the first screen. The scroll bar 191 is displayed in the display area not covered by the first screen. Note that the item boxes 115 are arranged side by side in the vertical direction, and the scroll bar 191 is provided to move the item boxes 115 in the vertical direction.

Further, in the present embodiment, the first screen is superimposed (specifically, the size and position of the item boxes 115 and the size of the display area of the first screen are set) such that the item box 115 positioned at the boundary between the non-display area and the display area of the second screen is partially hidden, namely, the item box 115 is displayed to be cut off in the middle. Thereby, the user can intuitively understand that some item boxes 115 are hidden in the part of the second screen covered by the first screen. Conversely, when an empty part greater than a prescribed size is created above the first screen, the user can intuitively understand that the all item boxes 115 are displayed.

An example shown in FIG. 17(A) illustrates a case of the face authentication result confirmation screen (see FIG. 10(C)) which is displayed when the face authentication is successful. In this case, in the second screen, the face authentication result, namely, the name of the user acquired by the face authentication (message 126) is displayed. With this second screen, the user can confirm the face authentication result. Also, the first screen includes, together with the cost calculation result (the cost calculation result display portion 116), the “Yes” button 127 and the “Wrong” button 128 as an operation part with which the user selects whether to approve the face authentication result displayed in the second screen. Therefore, the user can confirm the face authentication result with the second screen, and if no error is found in the face authentication, can perform an operation to approve the face authentication result with the first screen.

An example shown in FIG. 17(B) illustrates a case of the payment verification screen (see FIG. 11(B)) which is displayed when the password authentication is successful. In this case, the second screen is provided with the numeric keypad 133 as a unit for entering the PIN (password). Also, the first screen includes the cost calculation result (the cost calculation result display portion 116) and is provided with the “Pay” button 135 and the “Cancel checkout” button 119 as an operation part with which the user selects whether to proceed to checkout (payment). Therefore, the user can instruct execution of checkout (payment) with the first screen when the password authentication is successful.

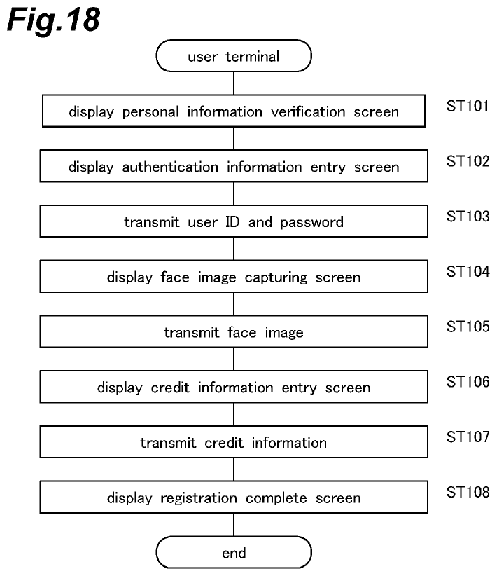

Next, a description will be made of an operating procedure of the user terminal 11 at the time of user registration. FIG. 18 is a flowchart showing an operating procedure of the user terminal 11 at the time of user registration.

When activated after installation of the application for the first time, the user terminal 11 first displays a personal information verification screen (ST101). In this personal information verification screen, a consent related to the handling of the personal information is displayed. When the user performs an operation to approve the consent in the personal information verification screen, an authentication information entry screen is displayed (ST102).

Subsequently, when the user performs an operation of entering the user ID and the password in the authentication information entry screen, the user terminal 11 transmits the user ID and the password to the user management server 13 (ST103). Then, the user terminal 11 displays a face image capturing screen (ST104). When the user performs an operation for capturing an image of his/her own face in the face image capturing screen, the user terminal 11 extracts a face image from the captured image, and transmits the face image to the user management server 13 (ST105).

At this time, the user management server 13 performs a process of registering the user ID and the password acquired from the user terminal 11. Also, the user management server 13 transmits the face image acquired from the user terminal 11 to the face authentication server 15, and the face authentication server 15 performs a process of registering the face image.

Subsequently, the user terminal 11 displays the credit information entry screen (ST106). When the user performs an operation of entering the credit information in the credit information entry screen, the user terminal 11 transmits the credit information to the payment server 12 (ST107). The payment server 12 performs a process of registering the credit information acquired from the user terminal 11.

Then, upon receipt of a notification of completion of the credit information registration from the payment server 12, the user terminal 11 displays a registration complete screen (ST108).

Note that the user can perform the operation of user registration at the register 4 installed in the store also, and the procedure therefor is the same as in the case of the user terminal 11.

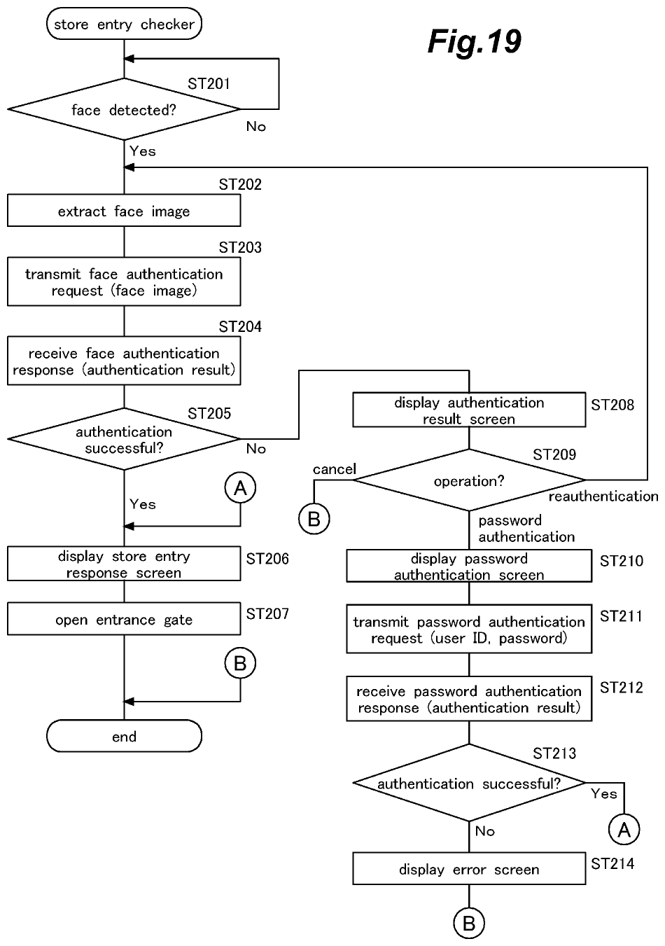

Next, a description will be made of an operating procedure of the store entry checker 1. FIG. 19 is a flowchart showing an operating procedure of the store entry checker 1.

First of all, when the store entry checker 1 detects a face of a person from an image captured by the camera 81 (Yes in ST201), the store entry checker 1 extracts a face image from the captured image (ST202) and transmits a face authentication request including the face image to the face authentication server 15 (ST203). At this time, in response to the face authentication request, the face authentication server 15 performs face authentication based on the face image acquired from the store entry checker 1, and transmits a face authentication response including the authentication result to the store entry checker 1.

Then, the store entry checker 1 receives the face authentication response from the face authentication server 15 (ST204), and when the authentication result included in the face authentication response is success (Yes in ST205), the store entry checker 1 causes the store entry response screen (see FIG. 7(B)) to be displayed on the display 82 (ST206) and performs control to open the entrance gate 5 (ST207).

On the other hand, when the authentication result is failure (No in ST205), the store entry checker 1 displays the face authentication result screen (see FIG. 8(B)) (ST208). Then, when the user performs an operation of selecting password authentication in the face authentication result screen, specifically, when the user operates the “Input ID” button 104 (“password authentication” in ST209), the store entry checker 1 displays the password authentication screen (not shown in the drawings) (ST210).

Subsequently, when the user performs an operation of entering the user ID and the password in the password authentication screen, the store entry checker 1 transmits a password authentication request including the user ID and the password to the user management server 13 (ST211). At this time, in response to the password authentication request, the user management server 13 performs password authentication based on the user ID and the password acquired from the store entry checker 1, and transmits a password authentication response including the authentication result to the store entry checker 1. Note that the user management server 13 generates a store visitor list based on the authentication result of the face authentication performed by the face authentication server 15 and the authentication result of the password authentication performed by the user management server 13.

Then, the store entry checker 1 receives the password authentication response from the user management server 13 (Yes in ST212), and when the authentication result included in the password authentication response is success (Yes in ST213), the store entry checker 1 causes the store entry response screen (see FIG. 7(B)) to be displayed on the display 82 (ST206) and performs control to open the entrance gate 5 (ST207).

On the other hand, when the authentication result is failure (No in ST213), the store entry checker 1 displays an error screen (ST214) and ends the process. At this time, the control to open the entrance gate 5 is not performed.

Also, when the user performs an operation of selecting cancel in the face authentication result screen, specifically, when the user operates the “Cancel” button 105 (see FIG. 8(B)) (“cancel” in ST209), the store entry checker 1 ends the process. When the user performs an operation of selecting reauthentication (re-execution of face authentication) in the face authentication result screen (“reauthentication” in ST209), specifically, when the user operates the “Reauthenticate” button 103, the process returns to ST202 and the face authentication is performed again.

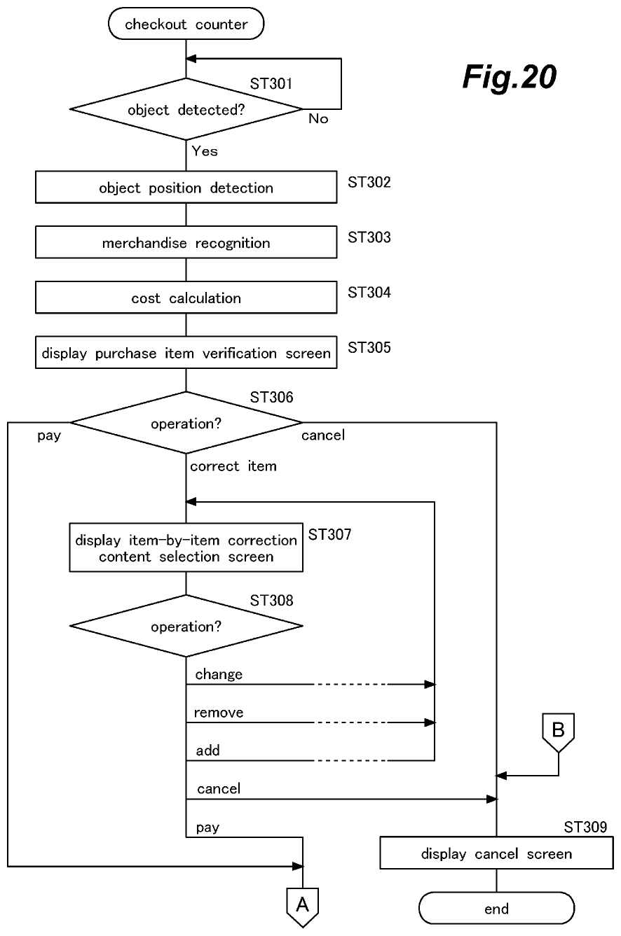

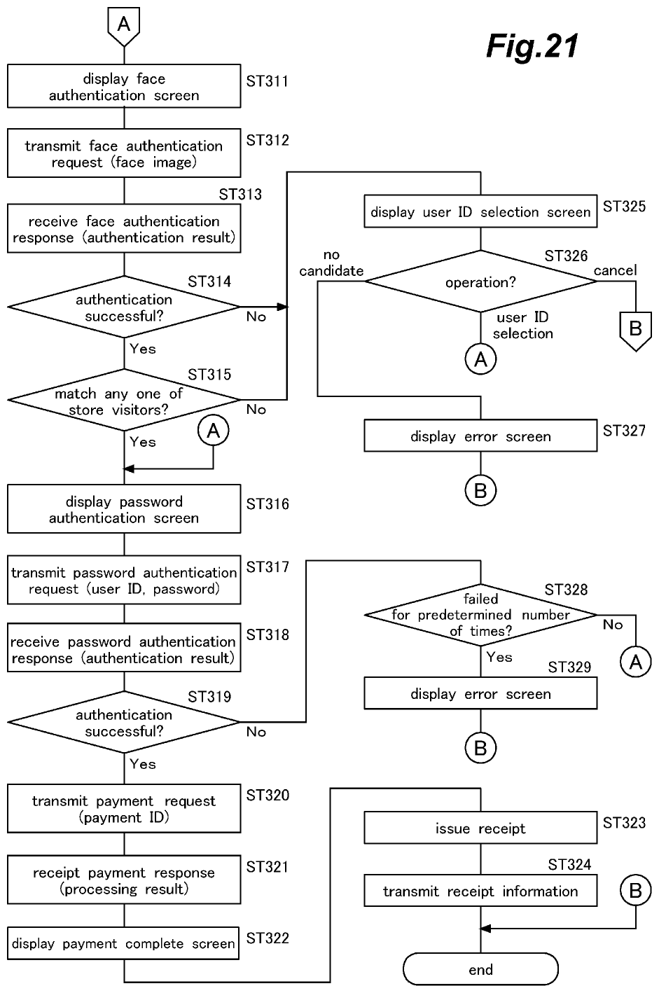

Next, a description will be made of an operating procedure of the checkout counter 2. FIGS. 20 and 21 are a flowchart showing an operating procedure of the checkout counter 2.

First of all, when the checkout counter 2 detects placement of one or more objects on the placement portion 41 based on the images captured by the cameras 51 (Yes in ST301), the checkout counter 2 detects the positions of the objects placed on the placement portion 41 (ST203). Subsequently, the checkout counter 2 identifies which merchandise item corresponds to each object placed on the placement portion 41 (ST303). Then, the checkout counter 2 calculates the cost of the merchandise items placed on the placement portion 41 (ST304). Thereafter, the checkout counter 2 displays the purchase item verification screen (see FIG. 9(B)) (ST305).

Subsequently, when the user performs an operation of selecting cancel in the purchase item verification screen (see FIG. 9(B)), specifically, when the user operates the “Cancel checkout” button 119 (“cancel” in ST305), the screen transitions to the cancel screen (see FIG. 9(C)) (ST309). On the other hand, when the user performs an operation of selecting payment, specifically, when the user operates the “Proceed to checkout” button 117 (“pay” in ST305), the process proceeds to face authentication and the face authentication screen (see FIG. 10(A)) is displayed (ST311).

On the other hand, when the user performs an operation of selecting merchandise item correction in the purchase item verification screen (see FIG. 9(B)), specifically, when the user operates the “Correct item” button 118 (“correct item” in ST305), the screen transitions to the item-by-item correction content selection screen (see FIG. 13(A)) (ST307).

Then, when the “Change” button 154 is operated in the item-by-item correction content selection screen (see FIG. 13(A)) (“change” in ST308), the screen transitions to the category selection screen (see FIG. 13(B)). Also, when the “Remove” button 153 is operated (“remove” in ST308), the screen transitions to the removal verification screen (see FIG. 14(B)). Also, when the “Add insufficient item” button 155 is operated (“add” in ST308), the screen transitions to the category selection screen (see FIG. 15(A)). Thereafter, when a desired operation is performed, the screen returns to the item-by-item correction content selection screen (ST307). At this time, the item-by-item correction content selection screen is displayed in a state reflecting the operation content.

Also, when the user performs an operation of selecting cancel, specifically, when the user operates the “Cancel checkout” button 119 (“cancel” in ST305), the screen transitions to the cancel screen (see FIG. 9(C)) (ST309). When the user performs an operation of selecting payment, specifically, when the user operates the “Proceed to checkout” button 117 (“pay” in ST305), the process proceeds to face authentication and the face authentication screen (see FIG. 10(A)) is displayed (ST311).

Subsequently, the checkout counter 2 extracts a face image from the image captured by the camera 43 and transmits a face authentication request including the face image to the face authentication server 15 (ST312). At this time, in response to the face authentication request, the face authentication server 15 performs face authentication based on the face image acquired from the checkout counter 2 and transmits a face authentication response including the authentication result to the checkout counter 2.

Then, the checkout counter 2 receives the face authentication response from the face authentication server 15 (ST313), and when the authentication result included in the face authentication response is success (Yes in ST314), subsequently determines whether the person of the authentication result matches any one of the store visitors. Specifically, the checkout counter 2 compare the authentication result with the store visitor list and confirms whether there is a person in the store visitor who is the same as the person of the authentication result. Note that in the face authentication, a person(s) having the degree of similarity (matching score) higher than a prescribed reference value is(are) selected and reported as the authentication result. Therefore, there may be a case in which the authentication result includes multiple persons having a high degree of similarity. In this case, from among the persons in the authentication result, a person included in the store visitor list is selected.

Here, when the person of the authentication result matches any one of the store visitors (Yes in ST315), the process proceeds to password authentication and the password authentication screen (see FIG. 11(A)) is displayed (ST316).

Subsequently, when the user enters a password (PIN) in the password authentication screen (see FIG. 11(A)), the checkout counter 2 transmits a password authentication request to the user management server 13 (ST317). At this time, in response to the password authentication request, the user management server 13 performs face authentication based on the face image acquired from the checkout counter 2 and transmits a face authentication response including the authentication result to the checkout counter 2.

Subsequently, the checkout counter 2 receives the password authentication response from the user management server 13 (ST318), and when the authentication result included in the password authentication response is success (Yes in ST319), transmits a payment request to the payment server 12 via the user management server 13 (ST320). Upon receipt of the payment request, the payment server 12 executes the payment process and transmits a payment response to the checkout counter 2 via the user management server 13.

Then, upon receipt of the payment response from the payment server 12 (ST321), the checkout counter 2 displays the payment complete screen (see FIG. 1) (ST322). Subsequently, the checkout counter 2 performs a receipt issuance process (ST323) and transmits the receipt information to the user terminal 11 via the user management server 13 (ST324). Then, upon receipt of the receipt information, the user terminal 11 stores the receipt information in the storage thereof.

On the other hand, when the authentication result is failure (No in ST314) or when the person of the authentication result does not match any one of the store visitors (No in ST315), the checkout counter 2 displays the user ID selection screen (see FIG. 12(A)) (ST325).

Subsequently, when the user performs an operation of user ID selection in the user ID selection screen (see FIG. 12(A)), specifically, when the user operates the user ID button 142 (“user ID selection” in ST326), the process proceeds to password authentication and the password authentication screen (see FIG. 11(A)) is displayed (ST316). Also, when the user performs an operation of “no candidate,” specifically, when the user operates the “No candidate” button 143 (“no candidate” in ST326), the error screen (see FIG. 12(B)) is displayed (ST328). Further, when the user performs a cancelling operation, specifically, when the user operates the “Cancel checkout” button 119 (“cancel” in ST326), the screen transitions to the cancel screen (see FIG. 9(C)) (ST309).

Also, when the authentication result of the password authentication is failure (No in ST319), then, it is determined whether the password authentication has failed consecutively for a predetermined number of times (ST328). Here, if the password authentication has not failed consecutively for the predetermined number of times (No in ST328), the process proceeds to the password authentication again and the password authentication screen for reentry (see FIG. 12(C)) is displayed (ST316). On the other hand, if the password authentication has failed consecutively for the predetermined number of times (Yes in ST328), the error screen (see FIG. 12(D)) is displayed (ST329).

Note that in the present embodiment, two-factor authentication consisting of the face authentication and the password authentication is adopted to enhance security, and the password authentication is performed even when the face authentication is successful, but it is possible to omit the password authentication and to perform only the face authentication.

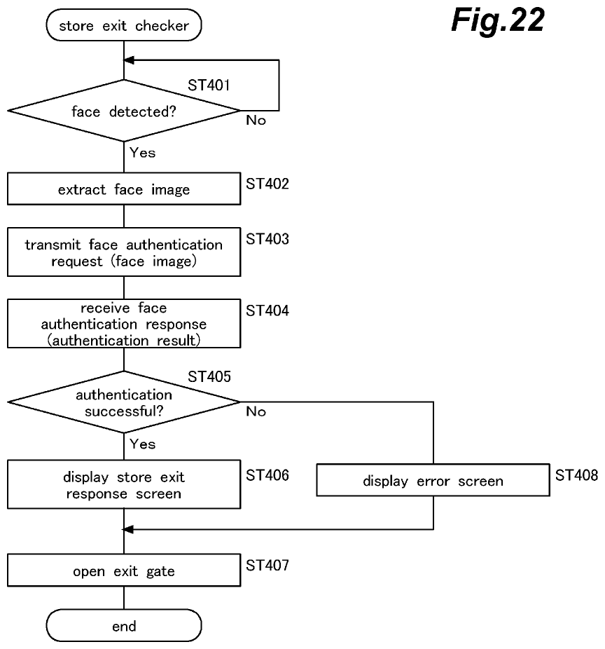

Next, a description will be made of an operating procedure of the store exit checker 3. FIG. 22 is a flowchart showing an operating procedure of the store exit checker 3.

First of all, when the store exit checker 3 detects a face of a person from an image captured by a camera (not shown in the drawings) (Yes in ST401), the store exit checker 3 extracts a face image from the captured image (ST402) and transmits a face authentication request including the face image to the face authentication server 15 (ST403). In response to the face authentication request, the face authentication server 15 performs face authentication and transmits a face authentication response to the store exit checker 3.

Then, the store exit checker 3 receives the face authentication response from the face authentication server 15 (ST404), and when the authentication result included in the face authentication response is success (Yes in ST405), the store exit checker 3 causes a store exit response screen (not shown in the drawings) to be displayed on a display (ST406) and performs control to open the exit gate 6 (ST407).

On the other hand, when the authentication result is failure (No in ST405), the store exit checker 3 causes an error screen (not shown in the drawings) to be displayed on the display (ST408) to guide other authentication methods such as re-execution of face authentication and entry of the user ID, and when the authentication is successful, the store exit checker 3 performs control to open the exit gate 6 (ST407).

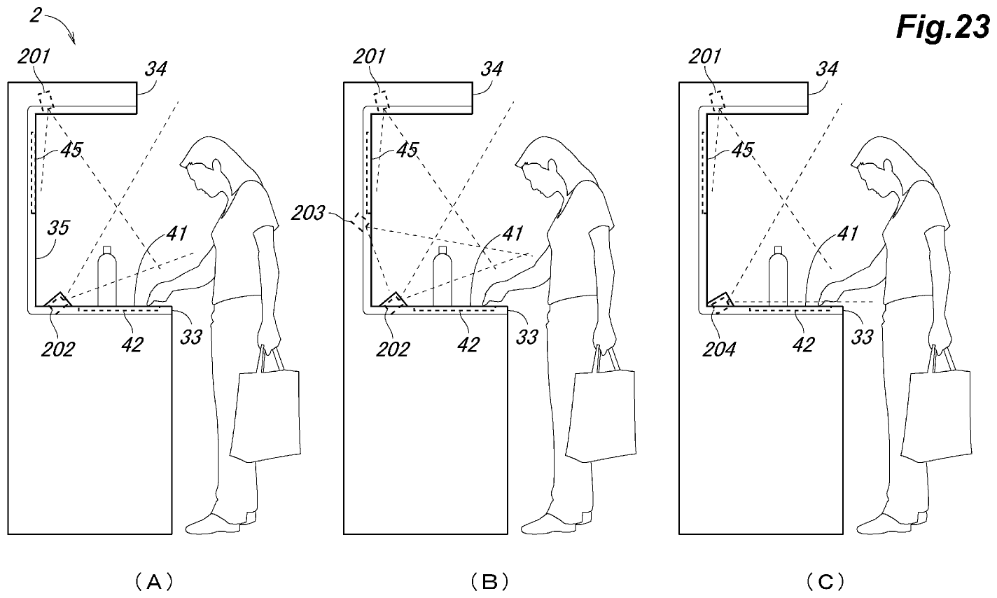

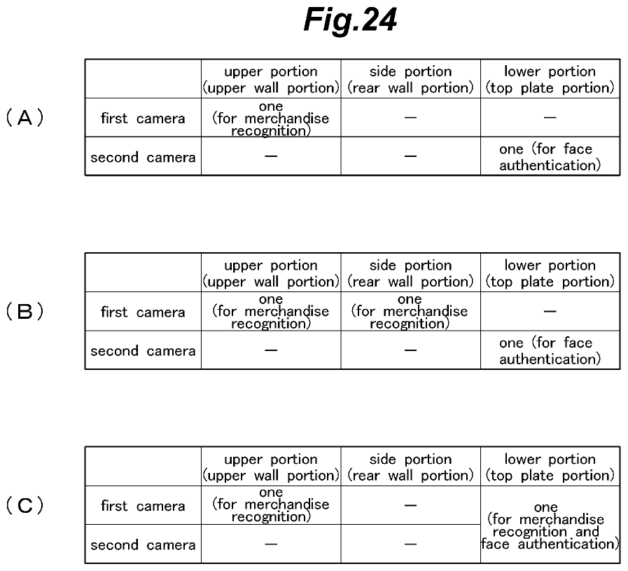

Next, a description will be made of modifications of the present embodiment. Note that the features not particularly mentioned here are the same as in the above-described embodiment. FIG. 23 shows side views illustrating the checkout counter 2 according to modifications of the present embodiment. FIG. 24 is an explanatory diagram showing configurations of the checkout counter 2 according to the modifications of the present embodiment.

As was shown in FIG. 4, the checkout counter 2 was provided with the projector 52 in the foregoing embodiment, but in these modifications, the projector is omitted.

In an example shown in FIG. 23(A), a camera 201 is provided on the upper wall portion 34. This camera 201 is a first camera for capturing an image of the merchandise items placed on the placement portion 41, and particularly, the captured image is used for the purpose of merchandise recognition. Also, a camera 202 is provided on the top plate portion 33. This camera 202 is a second camera for capturing an image of the face of the user looking at the touch panel display 42, and the captured image is used in the face authentication. The configuration of this modification is as shown in FIG. 24(A).

In an example shown in FIG. 23(B), as in the example shown in FIG. 21(A), the camera 201 is provided on the upper wall portion 34 and the camera 202 is provided on the top plate portion 33, but in this modification, a camera 203 is further provided on the rear wall portion 35. This camera 203 is a first camera for capturing an image of the merchandise items placed on the placement portion 41 and the captured image is used in the merchandise recognition. The configuration of this modification is as shown in FIG. 24(B). Since the rear wall portion 35 is provided with the display 45, the camera 203 should be disposed below the display 45, for example. In this configuration, captured images in which the merchandise items are shown from various directions are obtained, and therefore, the accuracy of the merchandise recognition can be enhanced.

In an example shown in FIG. 23(C), as in the examples shown in FIGS. 21(A) and (B), the camera 201 is provided on the upper wall portion 34. Also, a camera 204 is provided on the top plate portion 33, but the angle of view of this camera 204 is set such that the camera 204 can capture an image of both the merchandise items placed on the placement portion 41 and the face of the user looking at the touch panel display 42. Namely, the camera 204 serves both roles of the first camera for capturing an image of the merchandise items and the second camera for capturing the user's face, and the captured image is used for two purposes of merchandise recognition and face authentication. The configuration of this modification is as shown in FIG. 24(C). In this configuration, it is possible to capture images of the merchandise items from various directions without increasing the number of cameras.

Note that in the merchandise recognition based on the captured images obtained by multiple cameras, the merchandise items may be identified by integrating the results of merchandise recognition based on the respective captured images so as to avoid duplication.

Also, with the camera 204 on the top plate portion 33, an image of the imaging area including the merchandise items should be cut out for use in the merchandise recognition, and an image of the imaging area including the user's face should be cut out for use in the face authentication. Also, the camera 204 on the top plate portion 33 may be configured to be capable of changing the camera angle so that the camera angle is switched between when performing the merchandise recognition and when performing the face authentication.

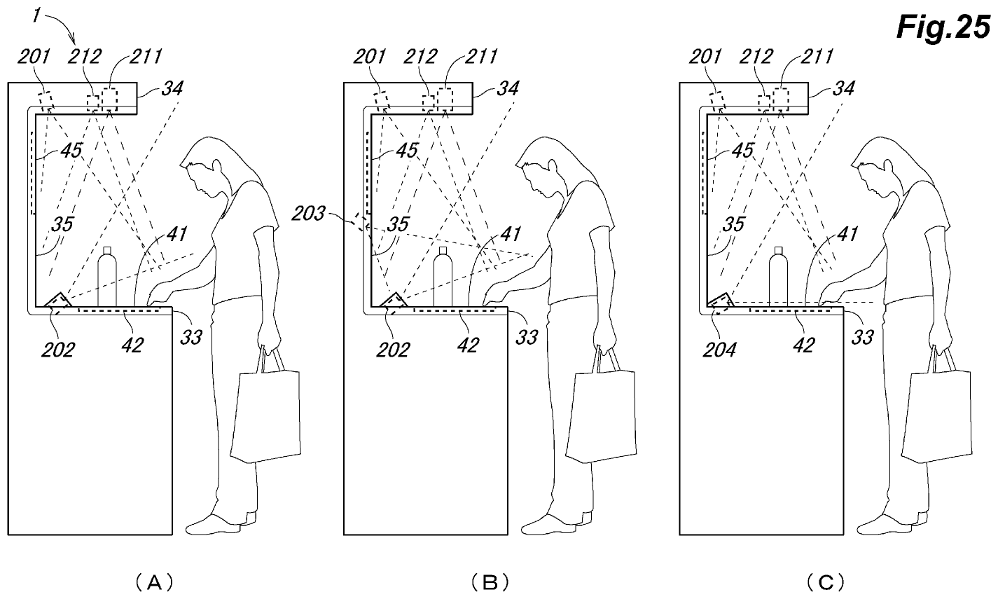

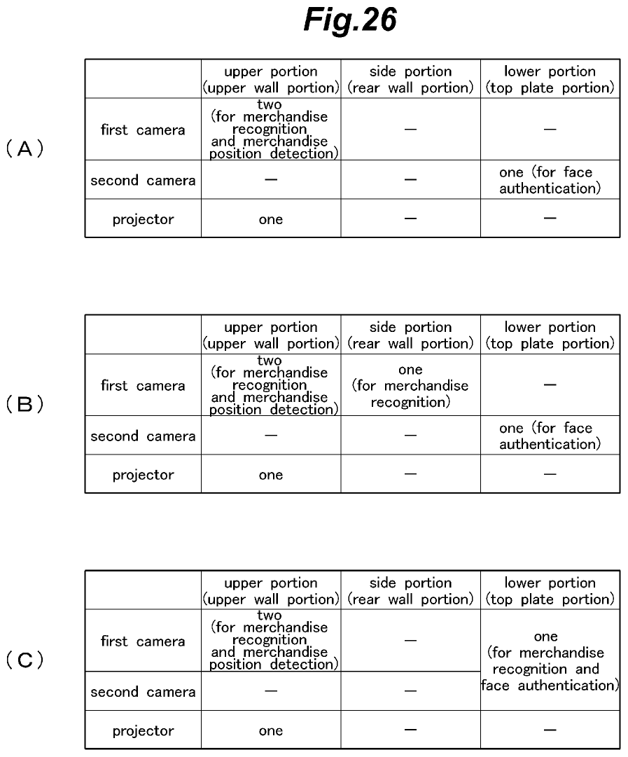

Next, a description will be made of other modifications of the present embodiment. Note that the features not particularly mentioned here are the same as in the above-described embodiment. FIG. 25 shows side views illustrating the checkout counter 2 according to other modifications of the present embodiment. FIG. 26 is an explanatory diagram showing configurations of the checkout counter 2 according to the other modifications of the present embodiment.

In the examples shown in FIG. 23 and FIG. 24, the projector was omitted, but a projector is provided in these modifications.

In an example shown in FIG. 25(A), as in the example shown in FIG. 23(A), the camera 201 is provided on the upper wall portion 34 and the camera 202 is provided on the top plate portion 33, and further, a projector 211 is provided on the upper wall portion 34. This projector 211 projects an image representing the merchandise recognition result, specifically, the frame images 55 (see FIG. 5) onto the placement portion 41.

Unlike the example shown in FIG. 23(A), two cameras, the cameras 201, 212, are provided on the upper wall portion 34. These two cameras 201, 212 are each a first camera for capturing an image of the merchandise items placed on the placement portion 41, but one camera 212 captures an image of the placement portion 41 substantially from directly above and the captured image is used for the purpose of merchandise position detection in which the positions of the merchandise items placed on the placement portion 41 are detected, while the other the camera 201 captures an image of the placement portion 41 from obliquely above and the captured image is used for the purpose of merchandise recognition in which the merchandise items placed on the placement portion 41 are recognized. The configuration of this modification is as shown in FIG. 26(A). Note that a single captured image may be used for the both purposes of merchandise position detection and merchandise recognition.

In an example shown in FIG. 25(B), as in the example shown in FIG. 23(B), the camera 201 is provided on the upper wall portion 34, the camera 202 is provided on the top plate portion 33, and the camera 203 is provided on the rear wall portion 35, and further, a projector 211 is provided on the upper wall portion 34. The configuration of this modification is as shown in FIG. 26(B).

In an example shown in FIG. 25(C), as in the example shown in FIG. 23(C), the camera 201 is provided on the upper wall portion 34 and the camera 204 is provided on the top plate portion 33, and further, a projector 211 is provided on the upper wall portion 34. The configuration of this modification is as shown in FIG. 26(C).

Note that in the examples shown in FIG. 25, one camera 201 on the upper wall portion 34 is disposed at a position offset in a direction toward the far side of the checkout counter 2 to capture an image of the placement portion 41 from obliquely above, but similarly to the example shown in FIG. 5, it may be disposed at a position offset in the width direction of the checkout counter 2. Also, though one camera 212 for the merchandise position detection is enough, the greater the number of the cameras 201, 203 for the merchandise recognition is, the more the accuracy of the merchandise recognition can be enhanced.

In the foregoing, the embodiments have been described as examples of the technology disclosed in the present application. However, the technology of the present disclosure is not limited to this, and may be applied to embodiments in which change, replacement, addition, omission, etc. may be done. Also, the structural elements described in the foregoing embodiments may be combined to form new embodiments.

### INDUSTRIAL APPLICABILITY

The unstaffed store system and the unstaffed store management method according to the present disclosure have effects that, in the face authentication in a store, it is possible to avoid false identification of the users who purchased merchandise and to properly grasp the users who exited the store without purchasing merchandise, and are useful as an unstaffed store system and an unstaffed store management method for managing a status of use of an unstaffed store by pre-registered users by means of face authentication, or the like.

### LIST OF REFERENCE NUMERALS

1 store entry checker (first face authentication machine)
2 checkout counter (second face authentication machine)
3 store exit checker (third face authentication machine)
4 register
5 entrance gate
6 exit gate
11 user terminal
12 payment server
13 user management server
14 merchandise learning server
15 face authentication server
16 DB server (information storage)
17 analysis server (analysis device)

1. An unstaffed store system for managing a status of use of an unstaffed store by pre-registered users by face authentication, comprising:
a first face authentication machine configured to acquire, with a first camera, a face image of a user at a time of entry to the store and to perform a process related to face authentication for permitting entry of the user to the store based on the face image at the time of entry to the store;
a second face authentication machine configured to acquire, with a second camera, the face image of the user at a time of payment and to perform a process related to face authentication for allowing the user to make payment based on the face image at the time of payment; and
a third face authentication machine configured to acquire, with a third camera, the face image of the user at a time of exit from the store and to perform a process related to face authentication for confirming exit of the user from the store based on the face image at the time of exit from the store.

2. The unstaffed store system according to claim 1, wherein the first camera is installed in a vicinity of a gate device so that the face of the user entering the store is included in an imaging area, and
the first face authentication machine is configured to control opening and closing of the gate device according to a face authentication result.

3. The unstaffed store system according to claim 1, further comprising a display for displaying information related to cost calculation and face authentication,
wherein the second camera is installed in a vicinity of the display such that the face of the user viewing the display is included in an imaging area.

4. The unstaffed store system according to claim 1, wherein the second face authentication machine is a checkout counter with which the user performs an operation related to cost calculation and payment, and
the third camera is installed such that the face of the user facing the checkout counter installed near an exit of the store is not included in an imaging area.

5. The unstaffed store system according to claim 1, further comprising:
an information storage configured to accumulate information related to results of face authentication performed by the first to third face authentication machines; and
an analysis device configured to generate analysis information of each user who visited the store according to purchase or non-purchase of merchandise.

6. The unstaffed store system according to claim 1, further comprising a server device connected with the first face authentication machine, the second face authentication machine, and the third face authentication machine via a network,
wherein the server device is configured to perform a face authentication process based on the face images respectively acquired from the first face authentication machine, the second face authentication machine, and the third face authentication machine.

7. An unstaffed store management method for managing a status of use of an unstaffed store by pre-registered users by face authentication, comprising:
acquiring, with a first camera, a face image of a user at a time of entry to the store and performing face authentication for permitting entry of the user to the store based on the face image at the time of entry to the store;
acquiring, with a second camera, the face image of the user at a time of payment and performing face authentication for allowing the user to make payment based on the face image at the time of payment; and
acquiring, with a third camera, the face image of the user at a time of exit from the store and performing face authentication for confirming exit of the user from the store based on the face image at the time of exit from the store.
